(19) United States
(12) Patent Application Publication
(10) Pub. No.: US 2023/0122070 A1
(43) Pub. Date: Apr. 20, 2023

(54) DISCONTINUOUS RECEPTION DURING EARLY DATA TRANSFER

(71) Applicant: QUALCOMM INCORPORATED, San Diego, CA (US)

(72) Inventors: Mungal Singh DHANDA, Slough (GB); Raghuveer Ramakrishna Srinivas TARIMALA, Hyderabad (IN); Umesh PHUYAL, San Diego, CA (US); Bharat SHRESTHA, San Diego, CA (US)

(21) Appl. No.: 17/908,535

(22) PCT Filed: Apr. 9, 2021
(86) PCT No.: PCT/US2021/026598

§ 371 Date: Sep. 1, 2022

(30) Foreign Application Priority Data
Apr. 9, 2020 (IN) 202041015537

(51) Int. Cl. H04W 74/08; H04W 76/28

(52) U.S. Cl. CPC H04W 74/0833; H04W 76/28

(57) ABSTRACT

Methods, systems, and devices for wireless communications are described. The described techniques provide for a user equipment (UE) to transmit to a base station a first message of a random access procedure, and the UE may monitor a control channel according to a first monitoring configuration. The UE may receive the second message from the base station in response to the first message. The second message may include a grant for a set of uplink resources for transmitting a third message of the random access procedure. The UE may transmit the third message including a data payload to the base station using the uplink resources, where the third message may include a data payload. The UE may monitor the control channel according to a second monitoring configuration (e.g., monitoring fewer occasions for control information than the first monitoring configuration), and the UE may receive the fourth message.

CROSS REFERENCES

The present Application is a 371 national stage filing of International PCT Application No. PCT/US2021/026598 by DHANDA et al. entitled “DISCONTINUOUS RECEPTION DURING EARLY DATA TRANSFER,” filed Apr. 9, 2021; and claims priority to Indian Patent Application No. 202041015537 by DHANDA et al. entitled “DISCONTINUOUS RECEPTION DURING EARLY DATA TRANSFER,” filed Apr. 9, 2020, each of which is assigned to the assignee hereof, and each of which is expressly incorporated by reference in its entirety herein.

### FIELD OF TECHNOLOGY

The following relates generally to wireless communications and to discontinuous reception (DRX) for early data transfer (EDT).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, LTE-machine type communications (LTE-M) systems, enhanced machine type communications (eMTC) systems, narrowband Internet of Things (NB-IoT) systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-s-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support discontinuous reception (DRX) for early data transfer (EDT). Generally, the described techniques provide for a user equipment (UE) to transmit, to a base station, a first message of a random access procedure (e.g., a preamble for a random access procedure using EDT). The UE may monitor a control channel according to a first monitoring configuration for control information (e.g., by monitoring each consecutive set of resources configured for monitoring occasions that may include control information), for example, transmitted in a response message from the base station.

The UE may receive a second message (e.g., a response message for the random access procedure using EDT) from the base station in response to the first message by monitoring the control channel according to the first monitoring configuration. In some cases, the second message may include a grant for a set of uplink resources for transmitting a third message of the random access procedure to the base station. The UE may transmit the third message (e.g., an early data request of the random access procedure using EDT) to the base station using the first set of uplink resources, where the third message may include a data payload.

After transmitting the third message, the UE may monitor the control channel according to a second monitoring configuration for control information (e.g., monitoring resources of a subset of each monitoring occasion that may include control information), for example, transmitted in a completion message from the base station. In some cases, the UE may begin monitoring using the second monitoring configuration upon transmitting the third message. Alternatively, the UE may begin monitoring using the second monitoring configuration upon receiving a contention resolution message from the base station, for example, in response to the third message. The UE may receive the fourth message from the base station in response to the third message by monitoring the control channel according to the second monitoring configuration.

A method of wireless communication at a UE is described. The method may include transmitting a first message of a random access procedure to a base station, monitoring a control channel according to a first monitoring configuration for control information associated with a second message of the random access procedure, receiving the second message from the base station in response to the first message and based on monitoring the control channel according to the first monitoring configuration, the second message including a grant for a first set of uplink resources for transmitting a third message of the random access procedure to the base station, transmitting the third message to the base station using the first set of uplink resources, the third message including a data payload, monitoring the control channel according to a second monitoring configuration for control information associated with a fourth message of the random access procedure, where the second monitoring configuration is different than the first monitoring configuration, and receiving the fourth message from the base station in response to the third message and based on monitoring the control channel according to the second monitoring configuration.

An apparatus for wireless communication at a UE is described. The apparatus may include a processor, memory coupled with the processor, and instructions stored in the memory. The instructions may be executable by the processor to cause the apparatus to transmit a first message of a random access procedure to a base station, monitor a control channel according to a first monitoring configuration for control information associated with a second message of the random access procedure, receive the second message from the base station in response to the first message and based on monitoring the control channel according to the first monitoring configuration, the second message including a grant for a first set of uplink resources for transmitting a third message of the random access procedure to the base station, transmit the third message to the base station using the first set of uplink resources, the third message including a data payload, monitor the control channel according to a second monitoring configuration for control information associated with a fourth message of the random access procedure, where the second monitoring configuration is different than the first monitoring configuration, and receive the fourth message from the base station in response to the third message and based on monitoring the control channel according to the second monitoring configuration.

Another apparatus for wireless communication at a UE is described. The apparatus may include means for transmitting a first message of a random access procedure to a base station, monitoring a control channel according to a first monitoring configuration for control information associated with a second message of the random access procedure, receiving the second message from the base station in response to the first message and based on monitoring the control channel according to the first monitoring configuration, the second message including a grant for a first set of uplink resources for transmitting a third message of the random access procedure to the base station, transmitting the third message to the base station using the first set of uplink resources, the third message including a data payload, monitoring the control channel according to a second monitoring configuration for control information associated with a fourth message of the random access procedure, where the second monitoring configuration is different than the first monitoring configuration, and receiving the fourth message from the base station in response to the third message and based on monitoring the control channel according to the second monitoring configuration.

A non-transitory computer-readable medium storing code for wireless communication at a UE is described. The code may include instructions executable by a processor to transmit a first message of a random access procedure to a base station, monitor a control channel according to a first monitoring configuration for control information associated with a second message of the random access procedure, receive the second message from the base station in response to the first message and based on monitoring the control channel according to the first monitoring configuration, the second message including a grant for a first set of uplink resources for transmitting a third message of the random access procedure to the base station, transmit the third message to the base station using the first set of uplink resources, the third message including a data payload, monitor the control channel according to a second monitoring configuration for control information associated with a fourth message of the random access procedure, where the second monitoring configuration is different than the first monitoring configuration, and receive the fourth message from the base station in response to the third message and based on monitoring the control channel according to the second monitoring configuration.

In some examples of the method, apparatuses, and non-transitory computer-readable medium described herein, the first monitoring configuration includes a first spacing in time between monitoring occasions and the second monitoring configuration includes a second, different spacing in time between monitoring occasions.

In some examples of the method, apparatuses, and non-transitory computer-readable medium described herein, the second monitoring configuration includes a cycle time duration between each of a set of sets of monitoring occasions and an on duration for the each of the set of sets of monitoring occasions, the set of sets of monitoring occasions to be monitored according to the second monitoring configuration.

Some examples of the method, apparatuses, and non-transitory computer-readable medium described herein may further include operations, features, means, or instructions for receiving an indication of the second monitoring configuration from the base station, where monitoring the control channel according to the second monitoring configuration may be based on receiving the indication of the second monitoring configuration. Some examples of the method, apparatuses, and non-transitory computer-readable medium described herein may further include operations, features, means, or instructions for receiving broadcast information from the base station including the indication of the second monitoring configuration. Some examples of the method, apparatuses, and non-transitory computer-readable medium described herein may further include operations, features, means, or instructions for receiving a radio resource control (RRC) message or a media access control control element (MAC-CE) from the base station including the indication of the second monitoring configuration.

Some examples of the method, apparatuses, and non-transitory computer-readable medium described herein may further include operations, features, means, or instructions for receiving a contention resolution message from the base station based on monitoring the control channel according to the first monitoring configuration, where monitoring the control channel according to the second monitoring configuration may be based on receiving the contention resolution message. Some examples of the method, apparatuses, and non-transitory computer-readable medium described herein may further include operations, features, means, or instructions for beginning to monitor the control channel based on determining that the contention resolution message successfully completes contention resolution. In some examples of the method, apparatuses, and non-transitory computer-readable medium described herein, the contention resolution message includes an indication of the second monitoring configuration. In some examples of the method, apparatuses, and non-transitory computer-readable medium described herein, the indication of the second monitoring configuration includes a multiplication factor to be applied to a spacing between each monitoring occasion or applied to a cycle time duration between each of a set of sets of monitoring occasions.

Some examples of the method, apparatuses, and non-transitory computer-readable medium described herein may further include operations, features, means, or instructions for beginning to monitor the control channel according to a third monitoring configuration upon transmitting the third message of the random access procedure. Some examples of the method, apparatuses, and non-transitory computer-readable medium described herein may further include operations, features, means, or instructions for receiving a contention resolution message from the base station based on monitoring the control channel according to the third monitoring configuration, where the contention resolution message successfully completes contention resolution. In some examples of the method, apparatuses, and non-transitory computer-readable medium described herein, the third monitoring configuration may be the same as the second monitoring configuration. In some examples of the method, apparatuses, and non-transitory computer-readable medium described herein, the third monitoring configuration may be different than the second monitoring configuration, and the contention resolution message includes an indication of the second monitoring configuration.

Some examples of the method, apparatuses, and non-transitory computer-readable medium described herein may further include operations, features, means, or instructions for transmitting a capability indication to the base station indicating that the UE supports the second monitoring configuration, where monitoring the control channel according to the second monitoring configuration may be based on the capability indication. Some examples of the method, apparatuses, and non-transitory computer-readable medium described herein may further include operations, features, means, or instructions for transmitting the capability indication in the third message of the random access procedure. Some examples of the method, apparatuses, and non-transitory computer-readable medium described herein may further include operations, features, means, or instructions for transmitting the capability indication in a capability message prior to transmitting the first message. Some examples of the method, apparatuses, and non-transitory computer-readable medium described herein may further include operations, features, means, or instructions for monitoring the control channel according to the second monitoring configuration may be based on the base station supporting the second monitoring configuration.

A method of wireless communication at a base station is described. The method may include receiving a first message of a random access procedure from a UE, transmitting a second message to the UE in response to the first message, the second message including control information mapped to a first monitoring occasion determined according to a first monitoring configuration used by the UE for monitoring a control channel, the second message including a grant for a first set of uplink resources for the UE for transmitting a third message of the random access procedure, receiving the third message over the first set of uplink resources, the third message including a data payload, and transmitting a fourth message in response to the third message, the fourth message including control information mapped to a second monitoring occasion determined according to a second monitoring configuration used by the UE for monitoring the control channel, where the second monitoring configuration is different than the first monitoring configuration.

An apparatus for wireless communication at a base station is described. The apparatus may include a processor, memory coupled with the processor, and instructions stored in the memory. The instructions may be executable by the processor to cause the apparatus to receive a first message of a random access procedure from a UE, transmit a second message to the UE in response to the first message, the second message including control information mapped to a first monitoring occasion determined according to a first monitoring configuration used by the UE for monitoring a control channel, the second message including a grant for a first set of uplink resources for the UE for transmitting a third message of the random access procedure, receive the third message over the first set of uplink resources, the third message including a data payload, and transmit a fourth message in response to the third message, the fourth message including control information mapped to a second monitoring occasion determined according to a second monitoring configuration used by the UE for monitoring the control channel, where the second monitoring configuration is different than the first monitoring configuration.

Another apparatus for wireless communication at a base station is described. The apparatus may include means for receiving a first message of a random access procedure from a UE, transmitting a second message to the UE in response to the first message, the second message including control information mapped to a first monitoring occasion determined according to a first monitoring configuration used by the UE for monitoring a control channel, the second message including a grant for a first set of uplink resources for the UE for transmitting a third message of the random access procedure, receiving the third message over the first set of uplink resources, the third message including a data payload, and transmitting a fourth message in response to the third message, the fourth message including control information mapped to a second monitoring occasion determined according to a second monitoring configuration used by the UE for monitoring the control channel, where the second monitoring configuration is different than the first monitoring configuration.

A non-transitory computer-readable medium storing code for wireless communication at a base station is described. The code may include instructions executable by a processor to receive a first message of a random access procedure from a UE, transmit a second message to the UE in response to the first message, the second message including control information mapped to a first monitoring occasion determined according to a first monitoring configuration used by the UE for monitoring a control channel, the second message including a grant for a first set of uplink resources for the UE for transmitting a third message of the random access procedure, receive the third message over the first set of uplink resources, the third message including a data payload, and transmit a fourth message in response to the third message, the fourth message including control information mapped to a second monitoring occasion determined according to a second monitoring configuration used by the UE for monitoring the control channel, where the second monitoring configuration is different than the first monitoring configuration.

In some examples of the method, apparatuses, and non-transitory computer-readable medium described herein, the first monitoring configuration includes a first spacing in time between monitoring occasions and the second monitoring configuration includes a second, different spacing in time between monitoring occasions.

In some examples of the method, apparatuses, and non-transitory computer-readable medium described herein, the second monitoring configuration includes a cycle time duration between each of a set of sets of monitoring occasions and an on duration for the each of the set of sets of monitoring occasions, the set of sets of monitoring occasions to be monitored by the UE according to the second monitoring configuration.

Some examples of the method, apparatuses, and non-transitory computer-readable medium described herein may further include operations, features, means, or instructions for transmitting broadcast information including an indication of the second monitoring configuration.

Some examples of the method, apparatuses, and non-transitory computer-readable medium described herein may further include operations, features, means, or instructions for transmitting an RRC message or a MAC-CE to the UE including an indication of the second monitoring configuration.

Some examples of the method, apparatuses, and non-transitory computer-readable medium described herein may further include operations, features, means, or instructions for transmitting a contention resolution message to the UE, where mapping the control information associated with the fourth message to the second monitoring occasion determined according to the second monitoring configuration may be based on transmitting the contention resolution message. In some examples of the method, apparatuses, and non-transitory computer-readable medium described herein, the contention resolution message includes an indication of the second monitoring configuration. In some examples of the method, apparatuses, and non-transitory computer-readable medium described herein, the indication of the second monitoring configuration includes a multiplication factor to be applied to a spacing between each monitoring occasion or applied to a cycle time duration between each of a set of sets of monitoring occasions. In some examples of the method, apparatuses, and non-transitory computer-readable medium described herein, the contention resolution message includes control information transmitted in a third monitoring occasion determined according to the first monitoring configuration. In some examples of the method, apparatuses, and non-transitory computer-readable medium described herein, the contention resolution message includes control information transmitted in a third monitoring occasion determined according to a third monitoring configuration, the third monitoring configuration different than the second monitoring configuration.

Some examples of the method, apparatuses, and non-transitory computer-readable medium described herein may further include operations, features, means, or instructions for receiving a capability indication from the UE indicating that the UE supports the second monitoring configuration. Some examples of the method, apparatuses, and non-transitory computer-readable medium described herein may further include operations, features, means, or instructions for receiving the capability indication in the third message of the random access procedure.

### BRIEF DESCRIPTION OF THE DRAWINGS

FIG. 1 illustrates an example of a system for wireless communications that supports discontinuous reception (DRX) for early data transfer (EDT) in accordance with aspects of the present disclosure.

FIGS. 2 through 4 illustrate examples of process flows that support random access procedures for connection establishment in accordance with aspects of the present disclosure.

FIG. 5 illustrates an example of a message format for a communications scheme that supports DRX for EDT in accordance with aspects of the present disclosure.

FIG. 6 illustrates an example of a process flow that supports DRX for EDT in accordance with aspects of the present disclosure.

FIGS. 7 and 8 show block diagrams of devices that support DRX for EDT in accordance with aspects of the present disclosure.

FIG. 9 shows a block diagram of a communications manager that supports DRX for EDT in accordance with aspects of the present disclosure.

FIG. 10 shows a diagram of a system including a device that supports DRX for EDT in accordance with aspects of the present disclosure.

FIGS. 11 and 12 show block diagrams of devices that support DRX for EDT in accordance with aspects of the present disclosure.

FIG. 13 shows a block diagram of a communications manager that supports DRX for EDT in accordance with aspects of the present disclosure.

FIG. 14 shows a diagram of a system including a device that supports DRX for EDT in accordance with aspects of the present disclosure.

FIGS. 15 and 16 show flowcharts illustrating methods that support DRX for EDT in accordance with aspects of the present disclosure.

### DETAILED DESCRIPTION

The present disclosure describes techniques for using discontinuous reception (DRX) during early data transfer (EDT) random access procedures. A user equipment (UE) may perform a random access procedure (e.g., a random access channel (RACH) procedure) with a base station to access a wireless network, for example, when initially accessing the wireless network or during a handover. In some cases, the random access procedure may include four messages, for example, a random access request message (e.g., in addition or alternatively to a random access preamble message), a random access response message, a radio resource control (RRC) message such as an RRC request message, and a further RRC message such as an RRC setup message. In some cases, these messages may include, or be referred to as, a RACH Msg 1, a RACH Msg2, a RACH Msg3, and a RACH Msg4, respectively. In some cases, the random access procedure may also include a contention resolution message, for example, communicated with the RACH Msg4 or as a separate transmission in response to the RACH Msg3. Each of the messages of the random access procedure may be communicated using corresponding sets of resources (e.g., corresponding sets of time, frequency, and/or spatial resources).

In some random access procedures, the UE may transmit a random access request message to the base station using a set of resources (e.g., a set of RACH resources). The random access request message may be, for example, a physical random access channel (PRACH) transmission transmitted using a set of resources allocated for PRACH transmissions. In some cases, the random access request message may include a random access preamble that identifies the random access request message corresponding to the UE.

The base station may receive the random access request message and may, for example, identify that the random access preamble corresponds to the transmitting UE (e.g., according to a random access preamble identifier (RAPID)). In response, the base station may transmit the random access response message to the UE, where the random access response message may include a grant for a first set of uplink resources (e.g., a set of time, frequency, and/or spatial resources) for transmitting the RRC connection request message to the base station. The UE may use the uplink grant to transmit a first scheduled uplink transmission (e.g., the RRC connection request message for the random access procedure) to the base station. The RRC connection request message may, for example, indicate a configuration that the base station may use to establish a communication link with the UE, for example, including a random access preamble, an identifier of the UE, and like information. The base station and the UE may then communicate uplink and downlink transmissions using the configured communication link.

In some wireless communications systems, the base station and the UE may use EDT procedures to transmit uplink information (e.g., application data) from the UE to the base station using a message of the random access procedure (e.g., a Msg3 of a four-step random access procedure). EDT may provide relatively improved efficiency for communicating relatively small amounts of information (e.g., for communicating small amounts of data by devices in Internet of Things (IoT) installations) by reducing a total number of transmissions used to perform the random access procedure and communicate the information in a connectionless transfer (e.g., without moving to a connected state upon completion of the random access procedure).

In some cases, however, an application server may use a relatively long duration of time to process information (e.g., application data) received from the UE and to generate the corresponding downlink information to be provided to the UE via the base station. In such cases, the UE may continue to monitor resources of a control channel. During this time, the UE may consume a relatively large amount of power (e.g., in comparison to a low power mode or idle sate). Accordingly, techniques are provided herein by which the UE may enter a low power mode (e.g., a DRX mode) after transmitting an early data request message (e.g., an RRC request message) or after receiving a contention resolution message to conserve power until completing the random access procedure.

According to a DRX configuration, for example, the UE may monitor for control information during a subset of all monitoring occasions and, between these configured monitoring occasions, the UE may enter a low power mode (e.g., an idle mode). For example, the base station may configure the DRX operation for the UE during the random access procedure, where a configuration for the DRX operation may specify a spacing between control channel occasions for monitoring and/or an EDT-specific DRX cycle (e.g., according to a duration and time domain offset between control channel occasions). In some cases, the base station may configure the DRX operation dynamically (e.g., based on instantaneous conditions or other parameters) and/or the UE may determine aspects of the DRX operation based on particular conditions. In some examples, the UE may operate according to a DRX configuration based on an explicit indication (e.g., based on a command received from the base station) or an implicit indication (e.g., based on an indication that the base station supports the DRX operation). Thus, according to the techniques described herein for using DRX with EDT procedures, the UE may conserve a substantial amount of power and wireless resources by using its receiver to actively monitor for a relatively smaller duration of time.

Aspects of the disclosure are initially described in the context of a wireless communications system. Aspects of the disclosure are also described in the context of message formats and a process flow that relate to configuring and operating using DRX for EDT. Aspects of the disclosure are further illustrated by and described with reference to apparatus diagrams, system diagrams, and flowcharts that relate to DRX for EDT.

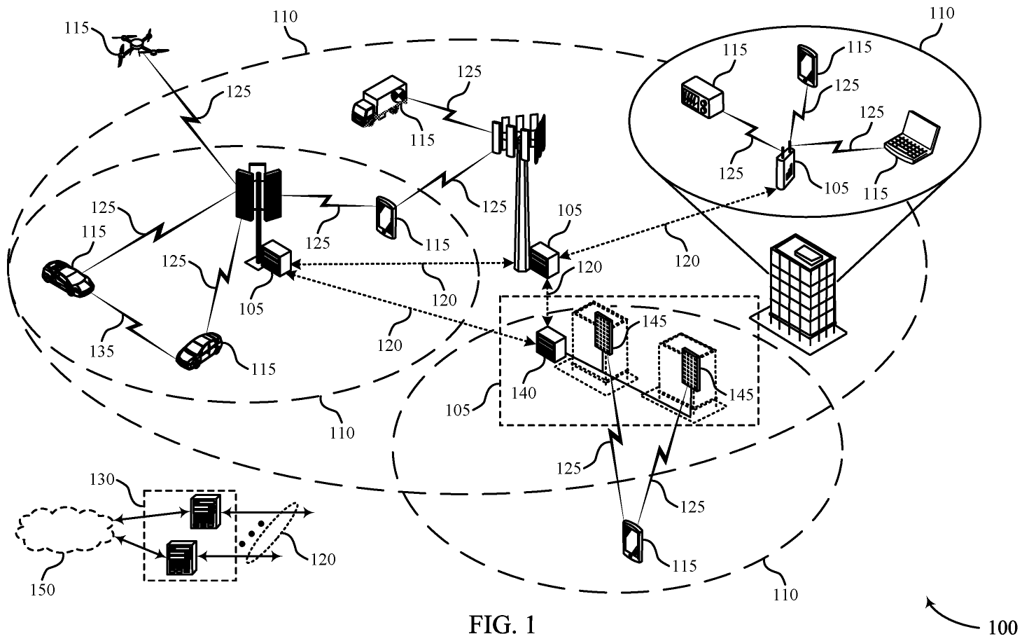

FIG. 1 illustrates an example of a wireless communications system 100 that supports DRX for EDT in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, an LTE-machine type communications (LTE-M) network, an enhanced machine type communications (eMTC) network, a narrowband IoT (NB-IoT) network, or a New Radio (NR) network. In some examples, the wireless communications system 100 may support enhanced broadband communications, ultra-reliable (e.g., mission critical) communications, low latency communications, communications with low-cost and low-complexity devices, delay tolerant communications, deep coverage communications, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an 51, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, LTE-M, NB-IoT, NR). Each physical layer channel may carry acquisition signaling (e.g., synchronization signals, system information (SI)), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-s-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of seconds (s), where may represent the maximum supported subcarrier spacing, and may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g.,) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., eMTC, NB-IoT, enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or fifth generation (5G) core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a base station 105 or a core network 130 supporting radio bearers for user plane data. At the physical layer, transport channels may be mapped to physical channels.

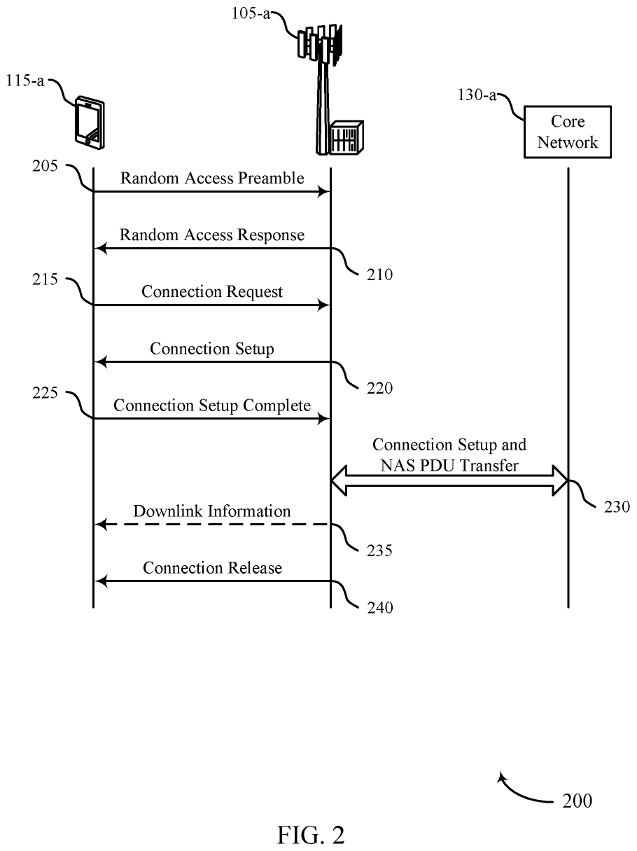

FIG. 2 illustrates an example of a process flow 200 that supports a random access procedure for connection establishment in accordance with aspects of the present disclosure. In some examples, the process flow 200 may be implemented by aspects of the wireless communications system 100, as described with reference to FIG. 1. The process flow 200 shows a base station 105-a , a UE 115-a , and a core network 130-a, which may each be examples of the corresponding devices described with reference to FIG. 1. Alternative examples of the following may be implemented, where some steps are performed in a different order than described or are not performed at all. In some cases, steps may include additional features not mentioned below and/or further steps may be added or removed.

The process flow 200 shows an example implementation of signaling for a mobile originated data transfer protocol using a random access procedure. In some cases, the random access procedure shown by the process flow 200 may be referred to as a four-step random access procedure (e.g., a four-step RACH procedure).

At 205, the UE 115-a may transmit to the base station 105-a, and the base station 105-a may receive from the UE 115-a, a message including a random access preamble. The random access preamble communicated at 205 may be a first message (e.g., Msg1) of the data transfer protocol shown by the process flow 200. In some cases, the UE 115-a may transmit a random access request message to the base station 105-a at 205, where the random access request message includes the random access preamble. In some cases, the random access preamble may be selected from a set of preamble sequences, such as a set of preamble sequences associated with a cell for communications for the UE 115-a.

At 210, the base station 105-a may transmit to the UE 115-a, and the UE 115-a may receive from the base station 105-a, a random access response message, for example, in response to successfully receiving the random access preamble from the UE 115-a at 205. The random access response message communicated at 210 may be a second message (e.g., Msg2) of the data transfer protocol shown by the process flow 200. In some cases, the random access response message may include a grant for a set of uplink resources that the UE 115-a may use to transmit a connection request message to the base station 105-b (e.g., at 215).

At 215, the UE 115-a may transmit to the base station 105-a, and the base station 105-a may receive from the UE 115-a, a connection request message. The connection request message communicated at 215 may be a third message (e.g., Msg3) of the data transfer protocol shown by the process flow 200. The connection request message may request a new connection, a reconfigured connection, and/or a resumption of connection with the base station 105-a for the UE 115-a. In some cases, the UE 115-a may transmit the connection request message via RRC signaling (e.g., in an RRC connection request message). In some cases, the UE 115-a and the base station 105-a may communicate the connection request message using the grant of resources indicated by the random access response message at 210.

At 220, the base station 105-a may transmit to the UE 115-a, and the UE 115-a may receive from the base station 105-a, a connection setup message, for example, in response to successfully receiving the connection request message from the UE 115-a at 215. The connection setup message communicated at 215 may be a fourth message (e.g., Msg4) of the data transfer protocol shown by the process flow 200. In some cases, the connection setup message may include a contention resolution message, which may be used to indicate that the random access procedure was successful for the UE 115-a (e.g., and not for another UE 115 that may have also been contending for access to the network via the base station 105-a).

At 225, the UE 115-a may transmit to the base station 105-a, and the base station 105-a may receive from the UE 115-a, a connection setup complete message. The connection setup complete message communicated at 225 may be a fifth message (e.g., Msg5) of the data transfer protocol shown by the process flow 200. The connection setup complete message may indicate that the UE 115-a has successfully performed the random access procedure and entered a connected state (e.g., an RRC connected state). Additionally or alternatively, the connection setup complete message may include one or more protocol data units (PDUs), for example, one or more NAS PDUs including NAS information pertaining to mobility, authentication, or bearer management for the UE 115-a.

At 230, the base station 105-a and the core network 130-a may perform a connection setup procedure to establish a session (e.g., a protocol data unit (PDU) session) for providing connectivity to the network for the UE 115-a and the base station 105-a (e.g., via the core network 130-a). Using the established PDU session, the base station may provide to the core network 130-a one or more PDUs (e.g., one or more NAS PDUs including NAS information pertaining to mobility, authentication, or bearer management for the UE 115-a), for example, based on information received from the UE 115-a at 225 or otherwise associated with the UE 115-a.

At 235, the base station 105-a may transfer downlink information to the UE 115-a. For example, the base station 105-a may transmit to the UE 115-a , and the UE 115-a may receive from the base station 105-a, one or more downlink data transmissions (e.g., using a physical downlink shared channel (PDSCH)). The downlink information communicated at 235 may be a sixth message (e.g., Msg6) of the data transfer protocol shown by the process flow 200. The downlink information may include one or more PDUs, for example, one or more NAS PDUs including NAS information relating to mobility, authentication, or bearer management for the UE 115-a. In some cases, for example, in response to the information provided to the core network at 130-a, the base station 105-a may receive from the core network 130-a corresponding downlink information for the UE 115-a (e.g., information obtained from an application server via the core network 130-a).

At 240, the base station 105-a may transmit to the UE 115-a, and the UE 115-a may receive from the base station 105-a, a connection release message. The connection release message communicated at 240 may be a seventh message (e.g., Msg7) of the data transfer protocol shown by the process flow 200. Accordingly, the UE 115-a may transmit the connection setup complete message (e.g., including a release assistance indicator that requests the network to allow the UE 115-a to enter an idle state) to the base station 105-a to request the base station 105-a to release the previously established connection, for example, because the UE 115-a does not have any further uplink information to transmit to the base station 105-a.

Accordingly, in the mobile originated data transfer protocol shown by the process flow 200 of FIG. 2, the UE 115-a and the base station 105-a may communicate up to seven (or more) independent messages to establish the connection to the core network 130-a for the UE 115-a via the base station 105-a, for the UE 115-a to communicate certain uplink information, and for the UE 115-a to receive corresponding downlink information from the base station 105-a. In some cases, however, the UE 115-a may have a relatively small amount of uplink information to communicate (and/or downlink information to be received). Each separate message of the data transfer protocol that is dependent on the message (or messages) before it may incur latency and increase an overall time needed to establish the connection and communicate the information. Thus, if the amount of information to be communicated is relatively small, techniques implemented to reduce the amount of messages to be communicated, correspondingly reducing an amount of time spent performing the data transfer protocol. For example, EDT procedures may be implemented in such situations to more efficiently utilize wireless resources and conserve power at the UE 115-a and/or the base station 105-a.

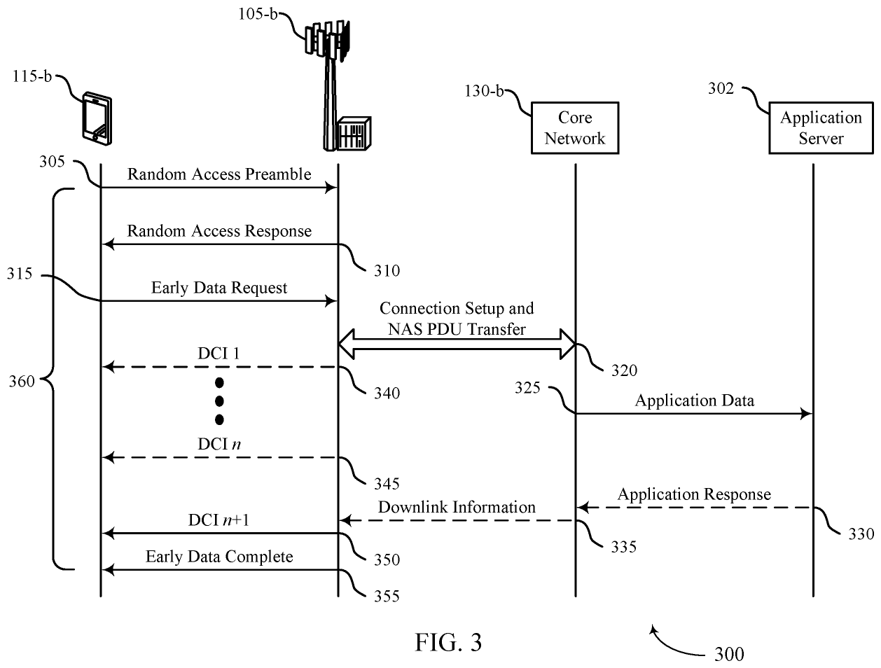

FIG. 3 illustrates an example of a process flow 300 that supports a random access procedure for connection establishment in accordance with aspects of the present disclosure. In some examples, the process flow 300 may be implemented by aspects of the wireless communications system 100, as described with reference to FIG. 1. The process flow 300 shows a base station 105-b, a UE 115-b, a core network 130-b, and an application server 302, which may each be examples of the corresponding devices described with reference to FIGS. 1 and 2. Alternative examples of the following may be implemented, where some steps are performed in a different order than described or are not performed at all. In some cases, steps may include additional features not mentioned below and/or further steps may be added or removed.

The process flow 300 shows an example implementation of signaling for a mobile originated data transfer protocol using a random access procedure in a wireless communications system that supports the use of DRX for EDT. Accordingly, the data transfer protocol shown by the process flow 300 may illustrate the use of an EDT procedure with a four-step random access procedure, where DRX techniques may also be used to conserve power, for example, at the UE 115-b. For example, using EDT procedures, the UE 115-b may communicate information (e.g., a relatively small amount of information) using shared channel resources associated with the random access procedure instead of UE-specific shared channel resources. Additionally, by implementing DRX, the UE 115-b may use a low power mode (e.g., a DRX mode) to conserve power during time periods that the UE 115-b may monitor for downlink transmissions (e.g., over a relatively long duration of time).

An EDT procedure with a four-step random access procedure may provide a mechanism by which a UE (e.g., a UE 115-b) may transmit uplink information (e.g., application data) to a base station (e.g., a base station 105-b) using a message of the random access procedure (e.g., a Msg3 of a four-step random access procedure). EDT may provide relatively improved efficiency for communicating relatively small amounts of information (e.g., for communicating small amounts of data by devices in IoT installations) by reducing a total number of transmissions used to perform the random access procedure and communicate the information in a connectionless manner (e.g., without the UE 115-b entering a connected state with the base station 105-b after completion of the random access procedure).

In some cases, the random access procedure shown by the process flow 300 may be referred to as a four-step random access procedure (e.g., a four-step RACH procedure), but the techniques described herein may similarly be utilized with other access procedures, such as with a two random access procedure (e.g., a two-step RACH procedure) and other like access procedures.

At 305, the UE 115-b may transmit to the base station 105-b, and the base station 105-b may receive from the UE 115-b, a message including a random access preamble. The random access preamble communicated at 305 may be a first message (e.g., Msg1) of the data transfer protocol shown by the process flow 300. In some cases, the UE 115-b may transmit a random access request message to the base station 105-b at 305, where the random access request message includes the random access preamble. In some cases, the random access preamble may be selected from a set of preamble sequences, such as a set of preamble sequences associated with a cell for communications for the UE 115-b.

At 310, the base station 105-b may transmit to the UE 115-b, and the UE 115-b may receive from the base station 105-b, a random access response message, for example, in response to successfully receiving the random access preamble from the UE 115-b at 305. The random access response message communicated at 310 may be a second message (e.g., Msg2) of the data transfer protocol shown by the process flow 300. In some cases, the random access response message may include a grant for a set of uplink resources that the UE 115-b may use to transmit an early data request to the base station 105-b (e.g., at 315). In some examples, the set of uplink resources may be associated with the occasion used for the random access preamble (e.g., allocated using DCI with a random access radio network temporary identifier (RA-RNTI) and not with a cell radio network temporary identifier (C-RNTI) associated with the UE 115-b).

At 315, the UE 115-b may transmit to the base station 105-b, and the base station 105-b may receive from the UE 115-b, an early data request message. The early data request message communicated at 315 may be a third message (e.g., Msg3) of the data transfer protocol shown by the process flow 300. The early data request message may include application data from the UE 115-b. For example, in the early data request message, the UE 115-b may transmit application data to the base station 105-b to be processed by the application server 302 and based on which the application server 302 may provide corresponding instructions or other data to the UE 115-b. Additionally or alternatively, the early data request message may include one or more PDUs such as NAS PDUs including NAS information pertaining to mobility, authentication, or bearer management for the UE 115-b. In some cases, the UE 115-b may transmit the early data request message via RRC signaling (e.g., in an RRC early data request message). In some cases, the UE 115-b and the base station 105-b may communicate the connection request message using the grant of resources indicated by the random access response message at 310. In some cases, the early data request message may additionally or alternatively request a new connection, to resume a connection, and/or to reconfigure a connection with the base station 105-b (e.g., for new resources over which the UE 115-b may subsequently communicate).

At 320, the base station 105-b and the core network 130-b may perform a connection setup procedure to establish a session (e.g., a PDU session) for providing connectivity to the network for the UE 115-b and the base station 105-b (e.g., via the core network 130-b). Using the established PDU session, the base station may provide, to the core network 130-b, application data received from the UE 115-b (e.g., according to information received from the UE 115-b in the early data request message at 315). Additionally or alternatively, the early data request message may include one or more PDUs such as NAS PDUs including NAS information pertaining to mobility, authentication, or bearer management for the UE 115-b), for example, based on information received from the UE 115-b at 315 or otherwise associated with the UE 115-b.

At 325, the core network 130-b may transmit to the application server 302, and the application server 302 may receive from the core network 130-b, an application data message. For example, the core network 130-b may provide the application data from the UE 115-b (e.g., as received from the base station 105-b via the core network 130-b at 320) in the application data message to the application server 302. The application server 302 may receive the application data message at 325 and process the information, for example, according to procedures and techniques configured for a particular application (e.g., as indicated by the information from the UE 115-b). Accordingly, the application server 302 may determine information to be provided to the base station 105-b and/or the UE 115-b via the core network 130-b based on the application data received at 325. For example, the application server 302 may determine downlink information to be provided to the UE 115-b via the base station 105-b and the core network 130-b for an application used by the UE 115-b (e.g., instructions for the UE 115-b). Additionally or alternatively, the application server 302 may determine that the UE 115-b does not need additional information, and the application server 302 may instead, via the core network 130-b, notify the base station 105-b accordingly.

At 330, the application server 302 may transmit to the core network 130-b, and the core network 130-b may receive from the application server 302, an application response message. For example, the application server 302 may provide determined downlink information for the UE 115-b to the base station 105-b via the core network 130-b in the application response 330, where the determined downlink information may be used by the UE 115-b for a particular application. Additionally or alternatively, the application server 302 may indicate to the base station 105-b, via the core network 130-b, in the application response message that the UE 115-b does not need additional information and that the data transfer protocol may be terminated.

At 335, the core network 130-b may transfer downlink information to the base station 105-b. For example, the core network 130-b may transmit to the base station 105-b, and the base station 105-b may receive from the core network 130-b, one or more data transmissions, including, for example, downlink information for the UE 115-b, using the resources of the random access procedure. The downlink information may include one or more PDUs, for example, one or more NAS PDUs including NAS information relating to mobility, authentication, or bearer management for the UE 115-b. In some cases, for example, based on the information received from the application server 302 in the application response at 330, the core network 130-b may transmit corresponding downlink information to the base station 105-b for the UE 115-a. Additionally or alternatively, the core network 130-b may indicate, to the base station 105-b, that the UE 115-b does not need additional information and that the base station 105-b may indicate to the UE 115-b, for example, that the application information received from the UE 115-b has been successfully received and processed by the application service server, and to terminate the data transfer protocol (e.g., via an early data complete message).

After transmitting the early data request message at 315, the UE 115-b may begin monitoring resources of a control channel. For example, UE 115-b may identify one or more occasions (e.g., physical downlink control channel (PDCCH) occasions) during which the UE 115-b may potentially receive control information from the base station 105-b, and the UE 115-b may monitor the wireless resources for the occasions. In some cases, the UE 115-b may continuously monitor these resources for control information that may be transmitted to the UE 115-b from the base station 105-b (e.g., continuously monitoring MTC PDCCH (MPDCCH) resources for eMTC applications or narrowband PDCCH (NPDCCH) resources for NB-IoT applications). For example, the UE 115-b may monitor for control information, such as one or more downlink control information (DCI) transmissions (e.g., over a PDCCH), during a first monitoring occasion at 330 through n subsequent monitoring occasions, for example, through an nth monitoring occasion at 345, as shown by the example process flow 300 of FIG. 3.

Based on receiving the downlink information from the core network 130-b at 335, the base station 105-b may transmit control information (e.g., DCI) to the UE 115-b during a configured monitoring occasion n+1. In some cases, however, the application server 302 may have taken a relatively long duration time to process the application information for the UE 115-b that the application server 302 may have received from the core network in the application data message at 325. Due to this time duration, as well as time for signal propagation and latency, the base station may not receive any information to be sent to the UE 115-b until the downlink information at 335, and thus the UE 115-b may continue monitoring (e.g., continuously) for the duration of time from the first monitoring period at 340 until receiving the downlink information in the monitoring period at 350.

At 350, for example, the base station 105-b may transmit to the UE 115-b, and the UE 115-b may receive from the base station 105-b, control information (e.g., a DCI message), for example, based on the downlink information received from the core network 130-b at 335. For example, the control information may indicate to the UE 115-b that the base station 105-b has received the downlink information from the core network 130-b and, for example, any corresponding instructions as may have been determined and provided by the application server 302. In some cases, the control information may additionally or alternatively indicate to the UE 115-b resources for receiving an early data complete message (e.g., at 355).

At 355, the base station 105-b may transmit to the UE 115-b, and the UE 115-b may receive from the base station 105-b, an early data complete message. The early data complete message communicated at 325 may be a fourth message (e.g., Msg4) of the data transfer protocol shown by the process flow 300.

In some cases, the early data complete message may include downlink information based on the information received from the UE 115-b in the early data request message at 315. For example, based on the application data received from the UE 115-b via the base station 105-b and the core network 103-c, the application server 302 may provide downlink information to the UE 115-b (e.g., instructions or other application information) via the early data complete message 325.

Additionally or alternatively, the early data complete message may include one or more PDUs such as NAS PDUs including NAS information relating to mobility, authentication, or bearer management for the UE 115-b . In some cases, for example, in response to the information provided to the core network at 130-b, the base station 105-b may receive from the core network 130-b downlink information for the UE 115-b (e.g., information obtained from an application server 302 via the core network 130-b), and the base station 105-b may provide this information to the UE 115-b in the early data complete message at 355.

In some cases, the early data complete message may indicate that the base station 105-b is to complete the random access procedure with the UE 115-b. Accordingly, the base station 105-b may transmit the early data complete message to the UE 115-b to signal to the UE 115-b to exit the random access procedure. After receiving the early data complete message at 355, the UE 115-b may enter a low power mode, such as an idle state. In other cases, the early data complete message may indicate to the UE 115-b that the UE 115-b is to enter a connected state, for example, an RRC connection for communicating additional data.

As described herein, the application server 302 may use a relatively long duration of time to process application information for the UE 115-b as may have been received from the core network in the application data message at 325. During this duration of time, in addition to the time to communicate the various signals, the UE 115-b may monitor for control information from the base station 105-b, for example, during the control resources of every TTI during the duration. In some applications, a time duration 360 between transmitting the early data request message at 315 and receiving the early data complete message at 355 may be relatively long, for example, up to 60 seconds (s) for an eMTC deployment or up to 120 s for an NB-IoT deployment. This length of time for the time duration 360 may allow the application server 302 (e.g., being outside of a public land mobile network (PLMN) of the base station 105-b) sufficient time to process the application data of the UE 115-b and respond to the UE 115-b accordingly. In some cases, the UE 115-b may start a timer (e.g., T300 timer) upon transmitting the random access preamble at 305, and may monitor for the early data complete message over the time duration 360 corresponding to the timer.

However, because the UE 115-b monitors for transmissions from the base station 105-b for, potentially, the entirety of the time duration 360, the UE 115-b may also consume power for this duration during which it does not receive or transmit any other signals. Accordingly, in some cases, the base station 105-b may signal a spacing parameter to the UE 115-b that indicates a spacing to be applied between monitoring occasions. For example, the base station 105-b may indicate such a spacing parameter to the UE 115-b (e.g., a parameter “mpdcch-start-SF-CSS-RA” and/or “pdcch-startSF-CS-RA” in SI, an SI block (SIB), broadcast information, or other signaling) that indicates that the UE 115-b is to apply a spacing (e.g., of a certain time duration) after each monitoring occasion before actively monitoring for the next monitoring occasion. According to this technique, however, a duration of time for the UE 115-b to receive the random access response message at 310 and correspondingly transmit the early data request message at 315 may be increased due to the less frequent monitoring.

Accordingly, techniques are provided herein by which the UE 115-b may be configured with and operate according to a DRX configuration. According to the DRX configuration, the UE 115-b may monitor for control information during a subset of all monitoring occasions and, between these configured monitoring occasions, the UE 115-b may enter a low power mode (e.g., may disable or power down a receiver). For example, the base station 105-b may configure the DRX operations for the UE 115-b, where the DRX configuration for the DRX operation may specify a spacing between control channel occasions for monitoring and/or an EDT-specific DRX cycle. An EDT-specific DRX cycle may include a cycle duration and a DRX on duration for monitoring control channel occasions, and may also include an offset for the DRX cycle. In some cases, the base station 105-b may configure the DRX configuration dynamically (e.g., based on instantaneous conditions or other parameters) and/or the UE 115-b may determine aspects of the DRX configuration based on particular conditions. Thus, according to the techniques described herein for using DRX with EDT procedures, the UE 115-b may conserve a substantial amount of power by using its receiver to actively monitor for a relatively smaller time.

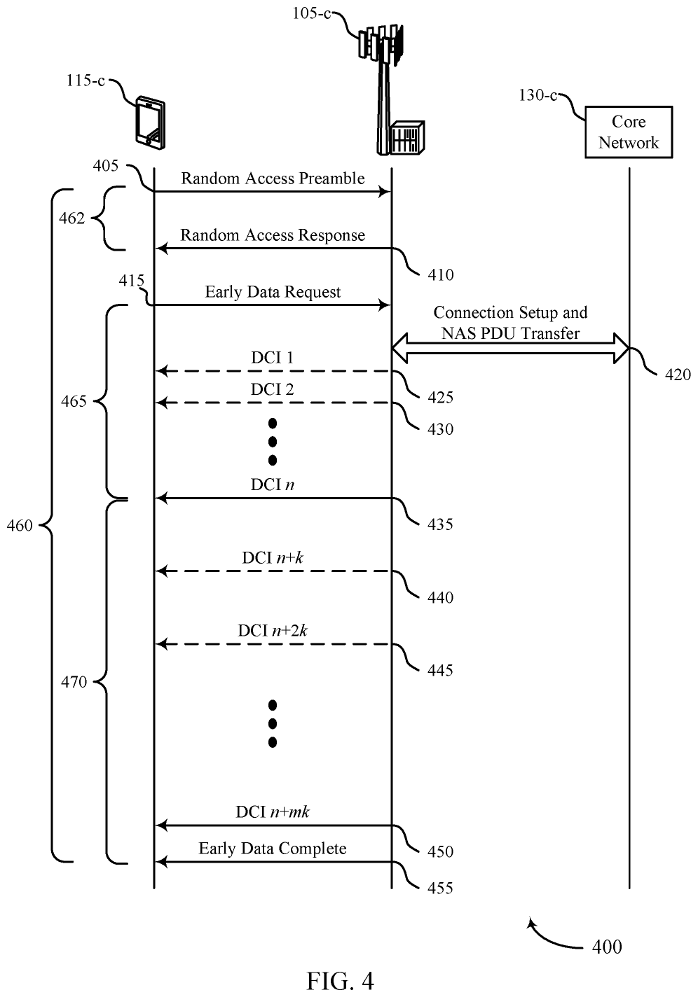

FIG. 4 illustrates an example of a process flow 400 that supports a random access procedure for connection establishment in accordance with aspects of the present disclosure. In some examples, the process flow 400 may be implemented by aspects of the wireless communications system 100, as described with reference to FIG. 1. The process flow 400 shows a base station 105-c, a UE 115-c, a core network 130-c, and an application server, which may each be examples of the corresponding devices described with reference to FIGS. 1 through 3. Alternative examples of the following may be implemented, where some steps are performed in a different order than described or are not performed at all. In some cases, steps may include additional features not mentioned below and/or further steps may be added or removed.

The process flow 400 shows an example implementation of signaling for a mobile originated data transfer protocol using a random access procedure in a wireless communications system that supports the use of DRX with EDT. Accordingly, the data transfer protocol shown by the process flow 400 may illustrate the use of an EDT procedure with a four-step random access procedure, where DRX techniques may also be used to conserve power, for example, at the UE 115-c. For example, using EDT procedures, the UE 115-c may communicate information (e.g., a relatively small amount of information) using shared channel resources associated with the random access procedure instead of UE-specific shared channel resources. Additionally, by implementing DRX, the UE 115-c may use a low power mode (e.g., a DRX mode) to conserve power during time periods that the UE 115-c may monitor for downlink transmissions (e.g., over a relatively long duration of time).

In some cases, the random access procedure shown by the process flow 400 may be referred to as a four-step random access procedure (e.g., a four-step RACH procedure), but the techniques described herein may similarly be utilized with other access procedures, such as with a two random access procedure (e.g., a two-step RACH procedure) and other like access procedures.

At 4405, the UE 115-c may transmit to the base station 105-c, and the base station 105-c may receive from the UE 115-c, a message including a random access preamble. The random access preamble communicated at 4405 may be a first message (e.g., Msg1) of the data transfer protocol shown by the process flow 400. In some cases, the random access preamble may be selected from a set of preamble sequences, such as a set of preamble sequences associated with a cell for EDT communications for the UE 115-c.

At 410, the base station 105-c may transmit to the UE 115-c, and the UE 115-c may receive from the base station 105-c, a random access response message, for example, in response to successfully receiving the random access preamble from the UE 115-c at 4405. The random access response message communicated at 410 may be a second message (e.g., Msg2) of the data transfer protocol shown by the process flow 400. In some cases, the random access response message may include a grant for a set of uplink resources that the UE 115-c may use to transmit an early data request to the base station 105-c (e.g., at 415).

At 415, the UE 115-c may transmit to the base station 105-c, and the base station 105-c may receive from the UE 115-c, an early data request message. The early data request message communicated at 415 may be a third message (e.g., Msg3) of the data transfer protocol shown by the process flow 400. The early data request message may include application data for the UE 115-c. For example, in the early data request message, the UE 115-c may transmit application data to the base station 105-c to be processed by an application server and based on which the application server may provide corresponding instructions or other data to the UE 115-c. Additionally or alternatively, the early data request message may include one or more PDUs such as NAS PDUs including NAS information pertaining to mobility, authentication, or bearer management for the UE 115-c. In some cases, the UE 115-c may transmit the early data request message via RRC signaling (e.g., in an RRC early data request message). In some cases, the UE 115-c and the base station 105-c may communicate the connection request message using the grant of resources indicated by the random access response message at 410.

At 420, the base station 105-c and the core network 130-c may perform a connection setup procedure to establish a session (e.g., a PDU session) for providing connectivity to the network for the UE 115-c and the base station 105-c (e.g., via the core network 130-c). Using the established PDU session, the base station may provide to the core network 130-c application data received from the UE 115-c (e.g., according to information received from the UE 115-c in the early data request message at 415). Additionally or alternatively, the early data request message may include one or more PDUs such as NAS PDUs including NAS information pertaining to mobility, authentication, or bearer management for the UE 115-c), for example, based on information received from the UE 115-c at 415 or otherwise associated with the UE 115-c.

After transmitting the early data request message at 415, the UE 115-c may begin monitoring resources of a control channel. For example, UE 115-c may identify one or more occasions (e.g., PDCCH occasions) during which the UE 115-c may potentially receive control information from the base station 105-c, and the UE 115-c may monitor the wireless resources for the occasions. In some cases, the UE 115-c may continuously monitor these resources (e.g., may monitor every occasion) for control information that may be transmitted to the UE 115-c from the base station 105-c (e.g., continuously monitoring MPDCCH resources for eMTC applications or NPDCCH resources for NB-IoT applications). For example, the UE 115-c may monitor for control information, such as one or more DCI transmissions (e.g., over a PDCCH), during a first monitoring occasion at 425 through n subsequent monitoring occasions, for example, through an nth monitoring occasion at 435, as shown by the example process flow 400 of FIG. 4.

At 435, the base station 105-c may transmit to the UE 115-c, and the UE 115-c may receive from the base station 105-c, control information (e.g., DCI) for the UE 115-c during the nth monitoring occasion, for example, based on receiving downlink information for the UE 115-c from the core network 130-c. For example, the control information may indicate to the UE 115-c that the base station 105-c has received the downlink information from the core network 130-c and, for example, any corresponding instructions as may have been determined and provided by the application server. In some cases, the control information may additionally or alternatively indicate to the UE 115-c resources for receiving an early data complete message (e.g., at 455).

In some cases, the UE 115-c may enter a DRX mode after transmitting the early data request message at 415 (e.g., immediately after transmitting the early data request message or following a duration of time after transmitting the early data request message). For example, the UE 115-c may begin monitoring according to a DRX configuration (e.g., as may have been received from the base station 105-c), and the UE 115-c may accordingly enter a low power mode after transmitting the early data request message at 415 and, for example, the UE 115-c may not monitor for control signaling at 425 and/or 430. Instead, the UE 115-c may exit the low power mode (e.g., wake up) to monitor for control signaling at 435, thus monitoring only a subset of each possible monitoring occasion.

In some cases, the UE 115-c may start a contention resolution timer 465 upon transmitting the early data request message at 415, where the UE 115-c may monitor for a contention resolution message for the duration of the contention resolution timer 465 (e.g., up to 10.24 s for eMTC FDD/TDD applications or up to 20.48 s for NB-IoT FDD applications). If, for example, the UE 115-c does not receive a contention resolution message within the duration of the contention resolution timer 465, the UE 115-c may restart a new random access procedure (e.g., transmitting a new random access preamble as shown at 4405). In some cases, the signaling at 435 may be or may include a contention resolution message, where the contention resolution message may indicate that the base station 105-c successfully received the early data request message from the UE 115-c and that the UE 115-c is the intended UE 115-c for the DRX configuration. For example, in some cases, multiple UEs 115 in the vicinity (e.g., in the cell) of the base station 105-c may transmit early data request messages to the base station 105-c, and thus the base station 105-c may transmit a contention resolution message (e.g., in DCI n at 435) to the UE 115-c (e.g., corresponding to an identifier for the UE 115-c) to indicate that the particular UE 115-c is connected with the network via its random access procedure.

In some cases, rather than applying the DRX configuration immediately upon transmitting the early data request message at 415, the UE 115-c may apply the DRX configuration after receiving the contention resolution message from the base station 105-c (e.g., in the control signaling at 435). In this way, the UE 115-c may enter the low power mode according to the DRX configuration after having received a confirmation that the base station 105-c has received the early data request message, which may prevent the UE 115-c from missing transmissions from the base station 105-c if the base station 105-c did not successfully receive the early data request message at 415. After receiving the contention resolution message, the UE 115-c may monitor, for example, every kth monitoring occasion (e.g., DCI slot) rather than each monitoring occasion. As shown in the example process flow 400 of FIG. 4, the UE 115-c may receive the contention resolution message at 435 and then subsequently monitor only a monitoring occasion 440 at a DCI slot n+k and a monitoring occasion 445 at a DCI slot n+2k (e.g., remaining in the power state for one or more monitoring occasions between each of the monitoring occasions 435, 440, and 445). In some cases, the UE 115-c may start a timer (e.g., T300 timer) upon transmitting the random access preamble at 4405, and may monitor for the early data complete message over the time duration 460 corresponding to the timer.

Accordingly, the UE may monitor according to different configurations during different time durations. For instance, in the example of FIG. 4, the UE may monitor a control channel according to a first configuration and a second configuration, where the first configuration may correspond to a continuous (e.g., each monitoring occasion) monitoring configuration and the second configuration may correspond to or be an example of a DRX configuration, such as an EDT DRX configuration. Each configuration may include a respective spacing in time between monitoring occasions. During a time duration 462 between communicating the random access preamble at 4405 and receiving the random access response at 410, the UE 115-c may monitor a control channel according to the first monitoring configuration (e.g., monitoring each monitoring occasion). During at time duration 470 after the contention resolution message at 435 (e.g., until the expiration of the timer corresponding to time duration 460) the UE 115-c may monitor the control channel according to the second monitoring configuration. In the time duration after communicating the early data request at 415 and before the contention resolution message at 435, the UE 115-c may monitor the control channel according to the first monitoring configuration, the second monitoring configuration, or a third monitoring configuration. In some cases, the third monitoring configuration may be the same as the first monitoring configuration or the second monitoring configuration, while in other cases the third monitoring configuration may be different from the first monitoring configuration and the second monitoring configuration. For example, the third monitoring configuration may correspond to a configured EDT DRX configuration without a multiplication factor and the second monitoring configuration may correspond to the configured EDT DRX configuration with the multiplication factor applied (e.g., as received in the contention resolution message at 435).

In some examples, the UE 115-c may monitor according to the second monitoring configuration based on an explicit indication from the base station 105-c. For instance, the base station 105-c may transmit a message (e.g., contention resolution message) to the UE 115-c instructing the UE 115-c to monitor according to the second monitoring configuration. Alternatively, in some examples, the UE 115-c may monitor according to the second monitoring configuration based on a determination of an implicit indication. For example, the UE 115-c may support a configured EDT DRX configuration and may determine that the base station 105-c also supports a configured EDT DRX configuration. The determination that the base station 105-c supports a configured EDT DRX configuration may be based on an indication received from the base station 105-c such as an indication in broadcast information (e.g., which may be one or more dedicated indication bits for EDT DRX, or may be an indication of one or more other capabilities that also indicate support for EDT DRX). Thus, upon completion of contention resolution (e.g., based on the contention resolution message at 435), the UE 115-c may determine to monitor according to the second monitoring configuration without an explicit indication to monitor according to the second monitoring configuration.

For example, the UE 115-c may determine to monitor after completion of contention resolution according to a parameter (m/n)pdcch-StartSF-CSS-EDT=multiplication_factor*(m/n)pdcch-startSF-CSS-RA, where the m or n may correspond to a type of the control channel (e.g., m for an eMTC or non-narrow band control channel PDCCH or MPDCCH and n for a narrow band control channel NPDCCH), (m/n)pdcch-startSF-CSS-RA may correspond to a spacing of MPDCCH/NPDCCH occasions for monitoring during random access (e.g., which may be used in the third monitoring configuration as discussed above). The multiplication_factor may be provided in a broadcast message (e.g., SIB), which may include one or more bits to indicate the factor. Thus, the second monitoring configuration may be implicitly indicated by the completion of contention resolution, and MPDCCH/NPDCCH occasions may be monitored in the second monitoring configuration in a spacing in time that is different from the first monitoring configuration according to multiplication_factor*(m/n)pdcch-startSF-CSS-RA, or different from the third monitoring configuration according to multiplication_factor.

In some cases, the base station 105-c may transmit control information to the UE 115-c before the expiration of the contention resolution timer 465 if the base station 105-c expects to receive a response from the application server based on the information provided to the core network 130-c at 420. In some cases, the UE 115-c may transmit an indication to the base station 105-c that the UE 115-c is expecting to receive such a response from the application server. For example, the UE 115-c may include a parameter in the early data request message indicating that the UE 115-c expects to receive a response (e.g., in a “Release Assistance Information” parameter). Based on receiving this indication that the UE 115-c expects to receive a response from the application server, the base station 105-c may transmit the contention resolution message to the UE 115-c before the expiration of the contention resolution timer 465. This may allow the UE 115-c to confirm that the base station 105-c received the early data request message and the UE 115-c may accordingly enter the low power mode according to the DRX configuration.

At 455, the base station 105-c may transmit to the UE 115-c, and the UE 115-c may receive from the base station 105-c, an early data complete message. The early data complete message communicated at 425 may be a fourth message (e.g., Msg4) of the data transfer protocol shown by the process flow 400. In some cases, the early data complete message may include downlink information based on the information received from the UE 115-c in the early data request message at 415. For example, based on the application data received from the UE 115-c via the base station 105-c and the core network 130-c, the application server may provide downlink information to the UE 115-c (e.g., instructions or other application information) via the early data complete message 425.

Additionally or alternatively, the early data complete message may include one or more PDUs such as NAS PDUs including NAS information relating to mobility, authentication, or bearer management for the UE 115-c. In some cases, for example, in response to the information provided to the core network at 130-c, the base station 105-c may receive from the core network 130-c downlink information for the UE 115-c (e.g., information obtained from an application server via the core network 130-c), and the base station 105-c may provide this information to the UE 115-c in the early data complete message at 455. In some cases, the base station 105-c and the UE 115-c may communicate the early data complete message using the grant of resources indicated by the random access response message at 410 and/or the resources requested via the early data request message at 415.

In some cases, the early data complete message may indicate that the base station 105-c is to release the connection established with the UE 115-c via the random access procedure at 4405 through 415. Accordingly, the base station 105-c may transmit the early data complete message to the UE 115-c to signal to the UE 115-c to release the previously established connection. After receiving the early data complete message at 455, the UE 115-c may enter a low power mode, such as an idle state. In other cases, the fourth message may be or include a connection setup message (e.g., an RRC connection setup message) to indicate to the UE 115-c that the UE 115-c is to enter connected state, for example, an RRC connection for communicating additional data.

The base station 105-c may transmit an indication of the DRX configuration to the UE 115-c using different signals shown in the process flow 400 and/or in additional signaling. For example, the base station 105-c may transmit the indication of the DRX configuration to the UE 115-c using dedicated signaling (e.g., dedicated signaling such as an “RRCConnectionRelease” message, an “RRCEarlyDataComplete” message, other RRC message, or other like signaling) that indicates the DRX configuration and/or indicates that the UE 115-c is to apply the DRX configuration. According to the signaling, the UE 115-c may apply the DRX configuration to the next random access procedure using EDT (or each of multiple subsequent EDT random access procedures). In some cases, the base station 105-c may configure a signal indicating the DRX configuration particularly (e.g., dynamically) for the UE 115-c, for example, based on knowledge of a response time for the application server.

Additionally or alternatively, the base station 105-c may transmit the indication of the DRX configuration to the UE 115-c using a broadcast message, for example, as part of broadcast information and/or in a SIB (e.g., a SIB2 transmission). This may the allow the UE 115-c to use the DRX configuration in a cell where the UE 115-c may not have received previous dedicated signaling indicating the DRX configuration. Additionally or alternatively, the base station 105-c may use a combination of dedicated signaling and SI. For example, the base station 105-c may broadcast parameters for the DRX configuration (e.g., in SI), but which the base station 105-c may override with one or more parameters configured specifically for the UE 115-c once the UE 115-c has determined specific DRX parameters may be beneficial for the UE 115-c (based on conditions for the channel such as signal quality, a priority of the communications of the UE 115-c, previous communications with the base station 105-c, or other like factors). In some cases, the base station 105-c may configure the UE-specific parameters such that the UE 115-c may apply the conditions for the UE-specific parameters only in a cell of the base station 105-c but not in other cells (e.g., making the UE-specific parameters valid particularly for the cell of the base station 105-c and/or other particular cells such as adjacent cells).

The DRX configuration may include one or more parameters that define how the UE 115-c is to monitor for control information. In some cases, the DRX configuration may define a spacing (e.g., in time) for the UE 115-c to use between monitoring occasions (e.g., relative to the spacing between each of the monitoring occasions). For example, the base station may signal a spacing parameter (e.g., given by a value for a parameter “(m/n)pdcch-StartSF-CSS-EDT,” where the value may be, for example, selected from the set of values {v2, v3, v4, v5, v7, v8, v9, v10} corresponding to a relatively larger spacing of a number of occasions between the occasions to monitor and/or a number of associated TTIs). Additionally or alternatively, the DRX configuration may be defined according to a DRX cycle time parameter (e.g., defining an “on duration” for the monitoring occasions and an “off duration” between the monitoring occasions), where the DRX cycle time may be configured according to an on duration parameter (e.g., a “onDurationTimer-EDT” parameter with values selected from, for example, the values 1, 2, . . . l); a DRX cycle length or duration parameter (e.g., a “drx-Cycle -EDT” parameter with values selected from, for example, a length of 1, 2, . . . m); and/or a cycle offset parameter of a time domain offset relative to a reference (e.g., a “drx-Cycle-Offset-EDT” parameter with values selected from, for example, the values 1, 2, . . . n). In some cases, the base station 105-c may provide the DRX configuration (e.g., according to techniques described herein) to each of the UEs 115 with which the base station 105-c is communicating (e.g., to each connected UE 115 in a cell of the base station 105-c).

In some cases, the UE 115-c may apply the DRX configuration (e.g., as the UE 115-c may have previously received from the base station 105-c) based on the UE 115-c supporting the DRX configuration (e.g., and based on the base station 105-c supporting the DRX configuration). Likewise, in some cases, the base station 105-c may configure the UE 115-c for the DRX configuration based on the UE 115-c having a capability to support the DRX configuration. That is, the UE 115-c may determine that the base station 105-c supports the DRX configuration 105-c and may apply the DRX configuration (e.g., upon completion of contention resolution) without an explicit indication from the base station 105-c, as discussed above. For example, the UE 115-c may transmit a capability indication to the base station 105-c indicating that the UE 115-c supports the DRX configuration. Based on the capability indication, the base station 105-c may communicate according to the DRX configuration (e.g., either implicitly configuring the UE to use the DRX configuration upon completion of contention resolution, or by explicitly configuring the UE 115-c with a DRX configuration for which the UE 115-c has a capability to use). In some cases, the UE 115-c may transmit the capability indication to the base station 105-c in an information element (e.g., in a UE-Capability information element in a previous uplink transmission, such as a “drxDuring-EDT” information element being set to true). Additionally or alternatively, the UE 115-c may transmit the capability indication to the base station 105-c in the early data request message at 415 (e.g., including the drxDuring-EDT information element for the control plane in a non-critical extension field for an “RRCEarlyDataRequest” message or for the user plane in a non-critical extension field for an “RRCConnectionResumeRequest” message). In some cases in which the UE 115-c transmits the capability indication in the early data request message, the capability indication may use a grant of a relatively large number of bits (e.g., 100 or more bits).

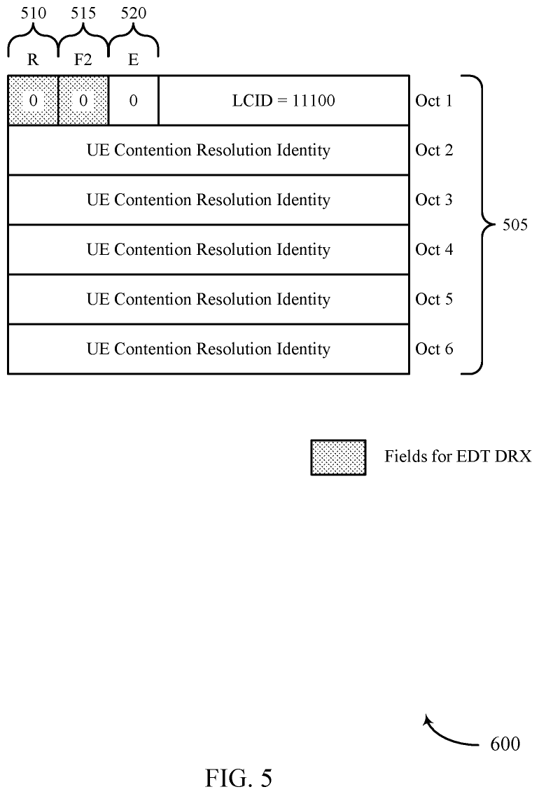

FIG. 5 illustrates an example of a message format 500 for a communications scheme that supports DRX for EDT in accordance with aspects of the present disclosure. In some examples, the message format 500 may be implemented by aspects of the wireless communications system 100, as described with reference to FIG. 1. The message format 500 illustrates a conceptual format for information to be conveyed in a contention resolution MAC PDU 505 for indicating a DRX configuration for use with EDT random access procedures between a base station and a UE, as described herein with reference to FIGS. 1 through 4. The MAC PDU 505 may be conveyed in a MAC control element (MAC-CE) message from the base station.

In some cases, the base station may dynamically configure a DRX configuration for EDT, for example, by various information bits in a MAC PDU 505. The example message format 500 of FIG. 5 shows the format of a contention resolution MAC PDU 505, for example, a MAC PDU 505 for a contention resolution message transmitted from the base station to the UE (e.g., to resolve contention during the pendency of a contention resolution timer). The MAC PDU 505 may include a first field 510 (e.g., an “R” field), a second field 515 (e.g., an “F2” field), and a third field 520 (e.g., an “E” field). In some cases, one or more of these fields may have other purposes, but these other purposes may, for example, be irrelevant, negligible, or inapplicable with EDT (e.g., a payload size field that indicates whether a payload size exceeds a threshold, but where the payload size may always be smaller than the threshold in the case of EDT). The MAC PDU 505 is also shown to include numerous other fields across six octets, but, in the example message format 500 of FIG. 5, these fields may be used to indicate other information also used for the contention resolution message. It is contemplated, however, that other fields of the MAC PDU 505 and/or fields of other messages or other types of messages may be used similarly to indicate DRX configurations in a similar way.

As shown in the example message format 500 of FIG. 5, the first field 510, the second field 515, and the third field 520 may be set to a value of zero, indicating the absence of a DRX configuration or that the DRX configuration is not enabled. In some cases, the value of the first field 510 and/or the second field 515 may be set to a value of one, which may indicate that the DRX configuration is enabled after contention resolution, for example, until the UE receives an early data complete message (e.g., indicating that the procedure is completed).

Alternatively, the base station may use the bits of the first field 510 and/or the second field 515 to dynamically apply DRX configurations for the UE. In this case, the UE may have been previously configured (e.g., in a previous broadcast or SI transmission from the base station or higher layer signaling) with one or more parameters for the DRX configuration, as similarly described herein. For example, in a first implementation, the DRX configuration may be configured according to a spacing between monitoring occasions. Alternatively, in a second implementation, the DRX configuration may be configured according to a DRX cycle time, a DRX cycle length or duration parameter, and/or a DRX cycle offset parameter.

With either the first or the second implementation, the base station may use the first field 510 and/or the second field 515 to apply a scalar (e.g., a multiplication factor) to the configured parameters for the spacing or the DRX cycle parameters, respectively. As a first example, for the first implementation in which a spacing between monitoring occasions may have been previously configured, the bits of the first field 510 and the second field 515 may be used to indicate a multiplication factor to be multiplied with the configured spacing value. For example, a multiplication factor parameter (e.g., “multiplication_factor”) may bemultiplied with the configured spacing parameter (e.g., either or both of “mpdcch-startSF-CSS-RA” or npdcch-startSF-CSS-RA″ and “mpdcch-startSF-CSS-EDT”). Likewise, the multiplication factor parameter (e.g., “multiplication_factor”) may be multiplied with the configured DRX cycle time and/or DRX cycle length (or duration) parameters (e.g., “drx-Cycle—EDT” and “onDurationTimer-EDT,” respectively).

For example, using one binary bit for each of the first field 510 and the second field 515, the base station may configure one of four values (00, 01, 10, and 11 for the R and F2 bits, respectively). In one example, implementation, a value of “00” may indicate that the DRX configuration is not enabled (e.g., where the UE may monitor each occasion), a value of “01” may indicate a multiplication factor of 1, a value of “10” may indicate a multiplication factor of 2, and a value of “11” may indicate a multiplication factor of 3. Other similarly implementations are contemplated, for example, multiplication factors of 1, 4, and 8, or any other like combination. The mappings of the values of these multiplication factors may be signaled to the UE, for example, in an SI transmission or other like signaling. In this way, the base station may relatively decrease an amount of information included in the transmission of a SIB by dynamically configuring at least some of the parameters of the DRX configuration. Additionally, the base station may relatively more dynamically modify the DRX configuration to be used by the UE (e.g., according to particular applications and, for example, based on previous delays in receiving responses from the application server).

As a second example, the base station may use only the first field 510 to indicate whether a multiplication factor is to be applied. For instance, when a spacing between monitoring occasions has been previously configured, the base station may further reduce signaling by using only the first field 510 to indicate if a multiplication factor is to be applied to the configured parameters for the spacing or the DRX cycle parameters, respectively. That is, a value of a multiplication factor parameter (e.g., “multiplication_factor”) may be previously configured or previously indicated (e.g., in a broadcast transmission, an SI transmission, or other like signaling), and the first field 510 may indicate if the multiplication factor should be applied or should not be applied. In such examples, the multiplication factor may be any value higher than 1. The bits of the first field 510 may indicate whether the multiplication factor parameter is to be applied. For example, using one binary bit for the first field 510, the base station may configure one of two values (e.g., 00 or 01 for the R bit). In one example, a value of “00” may indicate that the multiplication factor parameter is not to be applied, and a value of “01” may indicate that the multiplication factor is applied. As described above, the base station may use such signaling to relatively decrease an amount of information included in the transmission of a SIB.

In some cases, the base station may use a combination of the first example and the second example to configure the multiplication factor application. For example, the base station may use a combination of bits for the first field 510 and/or the second field 515 to indicate whether the multiplication factor should be applied and, if so, a value of the multiplication factor.

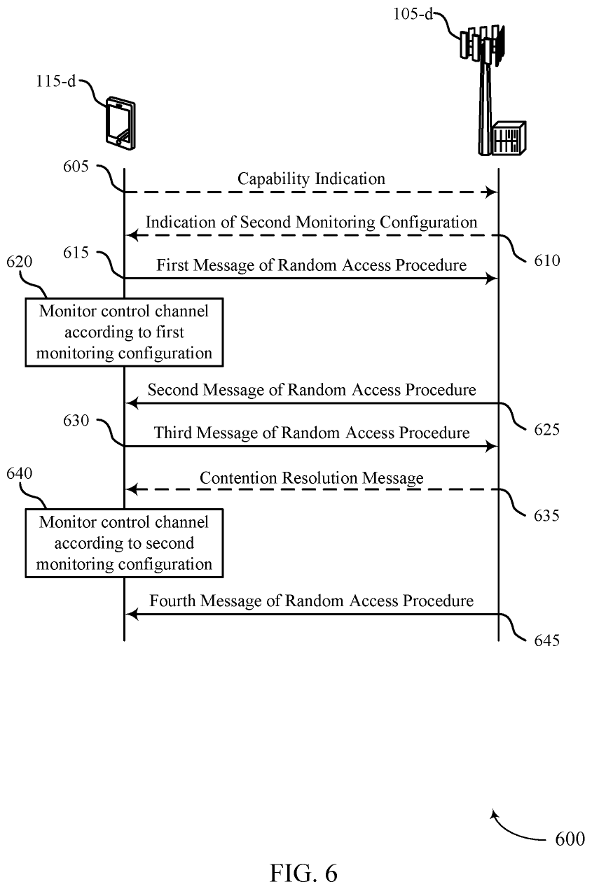

FIG. 6 illustrates an example of a process flow 600 that supports DRX for EDT in accordance with aspects of the present disclosure. In some examples, the process flow 600 may be implemented by aspects of the wireless communications system 100, as described with reference to FIG. 1. The process flow 600 shows a base station 105-d and a UE 115-d, which may be examples of the corresponding devices described with reference to FIGS. 1 through 5. Alternative examples of the following may be implemented, where some steps are performed in a different order than described or are not performed at all. In some cases, steps may include additional features not mentioned below and/or further steps may be added or removed.

At 605, the UE 115-d may transmit to the base station 105-d, and the base station 105-d may receive from the UE 115-d, a capability indication. The capability indication may indicate whether the UE 115-d supports different monitoring configurations (e.g., a DRX configuration for EDT, as described herein).

At 610, the base station 105-d may transmit to the UE 115-d, and the UE 115-d may receive from the base station 115-d, an indication of a second monitoring configuration. In some cases, the indication of the second monitoring configuration may be based on the UE 115-d supporting the second monitoring configuration (e.g., as indicated via the capability indication transmitted at 605). In some cases, the indication of the second monitoring configuration may be communicated via SI (e.g., a SIB broadcast transmission, such as a SIB1 or SIB2 transmission). Additionally or alternatively, the indication of the second monitoring configuration may be communicated via an RRC message. In some case, the indication of the second monitoring configuration may include a multiplication factor to be applied to a spacing between each of one or more monitoring occasions (e.g., monitoring occasions for the UE 115-d to monitor a control channel for signaling from the base station 105-d) or applied to a cycle time duration between each of a plurality of sets of monitoring occasions.

At 615, the UE 115-d may transmit to the base station 105-d, and the base station 105-d may receive from the UE 115-d, a first message of a random access procedure. The first message may include, for example, a preamble selected from a set of preamble sequences, such as a set of preamble sequences associated with a cell.

At 620, the UE 115-d may monitor the control channel according to a first monitoring configuration for control information associated with a second message of the random access procedure. For example, using the first monitoring configuration, the UE 115-d may monitor the control channel at each monitoring occasion of multiple monitoring occasions. In some cases, the first monitoring configuration may include a first spacing in time between monitoring occasions.

At 625, the base station 105-d may transmit to the UE 115-d, and the UE 115-d may receive from the base station 105-d, the second message of the random access procedure, for example, in response to the first message.

In some cases, UE 115-d may receive the second message based on monitoring the control channel according to the first monitoring configuration, for example, at 620. The second message may, for example, include control information mapped to a first monitoring occasion determined according to the first monitoring configuration. In some cases, the second message may include a grant for a first set of uplink resources for transmitting a third message of the random access procedure to the base station 105-d.

At 630, the UE 115-d may transmit to the base station 105-d, and the base station 105-d may receive from the UE 115-d, the third message of the random access procedure, for example, using the first set of uplink resources that may have been communicated in the second message at 625. In some cases, the third message may include a data payload (e.g., including user data), for example, according to the EDT procedures described herein. In some cases, the third message may be scrambled using a temporary network identifier for the UE 115-d.

At 635, the base station 105-d may transmit to the UE 115-d, and the UE 115-d may receive from the base station 105-d, a contention resolution message (e.g., in response to the third message as may have been communicated at 630). In some examples, the contention resolution message may be transmitted on the PDSCH and may be scrambled using the same temporary network identifier used to scramble the third message of the random access procedure (e.g., as may have been transmitted at 630). In some cases, the contention resolution message may include an indication of the second monitoring configuration (e.g., in place of, or in addition to, the indication of the second monitoring configuration that may be communicated at 610). In some cases, the contention resolution message may include a capability indication (e.g., in place of, or in addition to, the capability indication that may be communicated at 605).

At 640, the UE 115-d may monitor the control channel according to the second monitoring configuration for control information associated with a fourth message of the random access procedure, where the second monitoring configuration may be different than the first monitoring configuration (e.g., as may have been indicated via the indication of the second monitoring configuration communicated at 610). For example, the second monitoring configuration may include a second spacing in time between monitoring occasions that is different than the first spacing that is associated with the first monitoring configuration. In some cases, the UE 115-d may switching to monitoring the control channel according to the second monitoring configuration from a third monitoring configuration, where the UE 115-d may have previously switched to the third monitoring configuration upon transmitting the third message of the random access procedure at 630 (where, e.g., the third monitoring configuration may or may not be different than the second monitoring configuration).

In some cases, the UE 115-d may monitor the control channel according to the second monitoring configuration based on the contention resolution message, as may have been communicated at 635 (e.g., beginning to use the second monitoring configuration for monitoring upon receiving the contention resolution message at 635). In some cases, the UE 115-d may monitor the control channel according to the second monitoring configuration based on the contention resolution message having successfully completed a contention resolution procedure.

In some cases, the second monitoring configuration may include a spacing between each monitoring occasion of a plurality of monitoring occasions (e.g., including the second monitoring occasion) to be monitored according to the second monitoring configuration. In some cases, the second monitoring configuration may include a cycle time duration between each of multiple sets of monitoring occasions (e.g., including the second monitoring occasion) and an on duration for the each of the sets of monitoring occasions, where the sets of monitoring occasions may be monitored according to the second monitoring configuration.

At 645, the base station 105-d may transmit to the UE 115-d, and the UE 115-d may receive from the base station 105-d, the fourth message of the random access procedure, for example, in response to the third message. In some cases, UE 115-d may receive the fourth message based on monitoring the control channel according to the second monitoring configuration, for example, at 640. The fourth message may, for example, include control information mapped to a second monitoring occasion determined according to the second monitoring configuration.

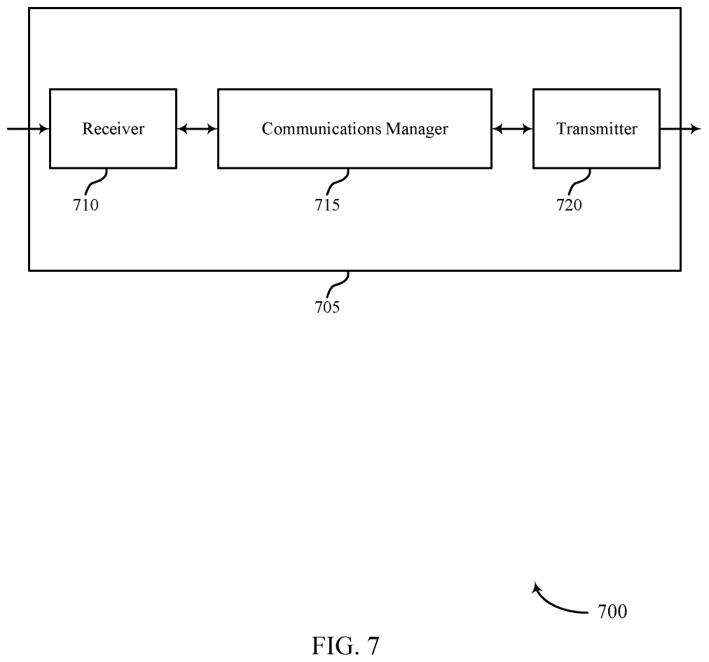

FIG. 7 shows a block diagram 700 of a device 705 that supports DRX for EDT in accordance with aspects of the present disclosure. The device 705 may be an example of aspects of a UE 115 as described herein. The device 705 may include a receiver 710, a communications manager 715, and a transmitter 720. The device 705 may also include a processor. Each of these components may be in communication with one another (e.g., via one or more buses).

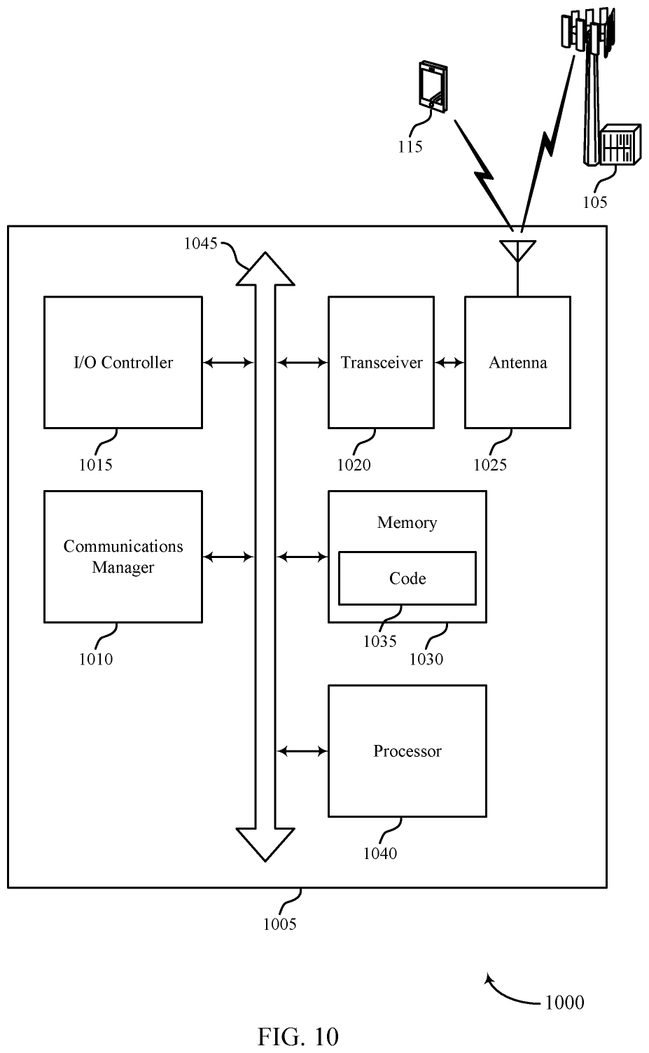

The receiver 710 may receive information such as packets, user data, or control information associated with various information channels (e.g., control channels, data channels, and information related to DRX for EDT, etc.). Information may be passed on to other components of the device 705. The receiver 710 may be an example of aspects of the transceiver 1020 described with reference to FIG. 10. The receiver 710 may utilize a single antenna or a set of antennas.

The communications manager 715 may transmit a first message of a random access procedure to a base station, monitor a control channel according to a first monitoring configuration for control information associated with a second message of the random access procedure, monitor the control channel according to a second monitoring configuration for control information associated with a fourth message of the random access procedure, where the second monitoring configuration is different than the first monitoring configuration, receive the second message from the base station in response to the first message and based on monitoring the control channel according to the first monitoring configuration, the second message including a grant for a first set of uplink resources for transmitting a third message of the random access procedure to the base station, transmit the third message to the base station using the first set of uplink resources, the third message including a data payload, and receive the fourth message from the base station in response to the third message and based on monitoring the control channel according to the second monitoring configuration. The communications manager 715 may be an example of aspects of the communications manager 1010 described herein.

The communications manager 715, or its sub-components, may be implemented in hardware, code (e.g., software or firmware) executed by a processor, or any combination thereof. If implemented in code executed by a processor, the functions of the communications manager 715, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 715, or its sub-components, may be physically located at various positions, including being distributed such that portions of functions are implemented at different physical locations by one or more physical components. In some examples, the communications manager 715, or its sub-components, may be a separate and distinct component in accordance with various aspects of the present disclosure. In some examples, the communications manager 715, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 720 may transmit signals generated by other components of the device 705. In some examples, the transmitter 720 may be collocated with a receiver 710 in a transceiver module. For example, the transmitter 720 may be an example of aspects of the transceiver 1020 described with reference to FIG. 10. The transmitter 720 may utilize a single antenna or a set of antennas.

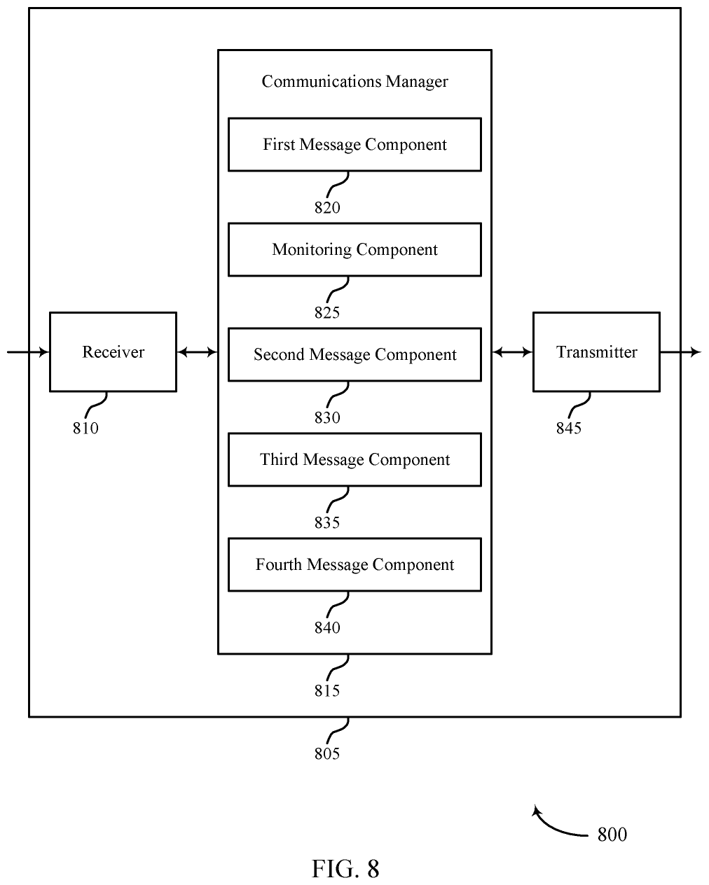

FIG. 8 shows a block diagram 800 of a device 805 that supports DRX for EDT in accordance with aspects of the present disclosure. The device 805 may be an example of aspects of a device 705, or a UE 115 as described herein. The device 805 may include a receiver 810, a communications manager 815, and a transmitter 945. The device 805 may also include a processor. Each of these components may be in communication with one another (e.g., via one or more buses).

The receiver 810 may receive information such as packets, user data, or control information associated with various information channels (e.g., control channels, data channels, and information related to DRX for EDT, etc.). Information may be passed on to other components of the device 805. The receiver 810 may be an example of aspects of the transceiver 1020 described with reference to FIG. 10. The receiver 810 may utilize a single antenna or a set of antennas.

The communications manager 815 may be an example of aspects of the communications manager 715 as described herein. The communications manager 815 may include a first message component 820, a monitoring component 825, a second message component 830, a third message component 835, and a fourth message component 840. The communications manager 815 may be an example of aspects of the communications manager 1010 described herein.

The first message component 820 may transmit a first message of a random access procedure to a base station.

The monitoring component 825 may monitor a control channel according to a first monitoring configuration for control information associated with a second message of the random access procedure and monitor the control channel according to a second monitoring configuration for control information associated with a fourth message of the random access procedure, where the second monitoring configuration is different than the first monitoring configuration.

The second message component 830 may receive the second message from the base station in response to the first message and based on monitoring the control channel according to the first monitoring configuration, the second message including a grant for a first set of uplink resources for transmitting a third message of the random access procedure to the base station.

The third message component 835 may transmit the third message to the base station using the first set of uplink resources, the third message including a data payload.

The fourth message component 840 may receive the fourth message from the base station in response to the third message and based on monitoring the control channel according to the second monitoring configuration.

The transmitter 845 may transmit signals generated by other components of the device 805. In some examples, the transmitter 845 may be collocated with a receiver 810 in a transceiver module. For example, the transmitter 845 may be an example of aspects of the transceiver 1020 described with reference to FIG. 10. The transmitter 845 may utilize a single antenna or a set of antennas.

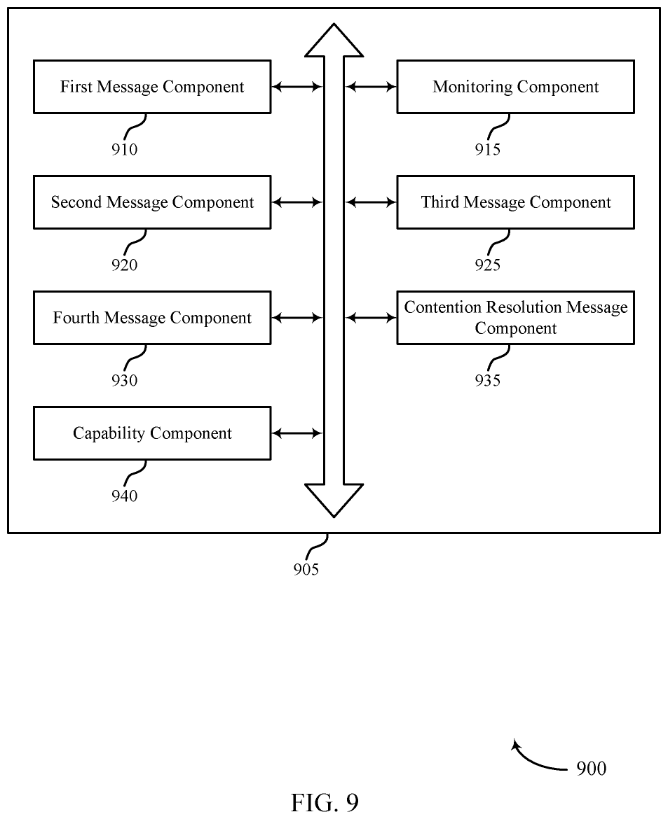

FIG. 9 shows a block diagram 900 of a communications manager 905 that supports DRX for EDT in accordance with aspects of the present disclosure. The communications manager 905 may be an example of aspects of a communications manager 715, a communications manager 815, or a communications manager 1010 described herein. The communications manager 905 may include a first message component 910, a monitoring component 915, a second message component 920, a third message component 925, a fourth message component 930, a contention resolution message component 935, and a capability component 945. Each of these modules may communicate, directly or indirectly, with one another (e.g., via one or more buses).

The first message component 910 may transmit a first message of a random access procedure to a base station.

The monitoring component 915 may monitor a control channel according to a first monitoring configuration for control information associated with a second message of the random access procedure.

In some examples, the monitoring component 915 may monitor the control channel according to a second monitoring configuration for control information associated with a fourth message of the random access procedure, where the second monitoring configuration is different than the first monitoring configuration.

In some examples, the monitoring component 915 may receive an indication of the second monitoring configuration from the base station, where monitoring the control channel according to the second monitoring configuration is based on receiving the indication of the second monitoring configuration. In some examples, the monitoring component 915 may receive broadcast information, an RRC message, or a MAC-CE from the base station including the indication of the second monitoring configuration.

In some cases, the first monitoring configuration includes a first spacing in time between monitoring occasions and the second monitoring configuration includes a second, different spacing in time between monitoring occasions. In some cases, the second monitoring configuration includes a cycle time duration between each of a plurality of sets of monitoring occasions and an on duration for the each of the plurality of sets of monitoring occasions, the plurality of sets of monitoring occasions to be monitored according to the second monitoring configuration. In some cases, the indication of the second monitoring configuration includes a multiplication factor to be applied to a spacing between each monitoring occasion or applied to a cycle time duration between each of a plurality of sets of monitoring occasions.

In some examples, monitoring the control channel according to the second monitoring configuration is based on the base station supporting the second monitoring configuration.

In some examples, the monitoring component 915 may begin to monitor the control channel based on determining that a contention resolution message successfully completes contention resolution. In some examples, the monitoring component 915 may begin to monitor the control channel according to a third monitoring configuration upon transmitting the third message of the random access procedure. In some cases, the third monitoring configuration is the same as the second monitoring configuration. In some cases, the third monitoring configuration is different than the second monitoring configuration, and the contention resolution message includes an indication of the second monitoring configuration.

The second message component 920 may receive the second message from the base station in response to the first message and based on monitoring the control channel according to the first monitoring configuration, the second message including a grant for a first set of uplink resources for transmitting a third message of the random access procedure to the base station.

The third message component 925 may transmit the third message to the base station using the first set of uplink resources, the third message including a data payload.

The fourth message component 930 may receive the fourth message from the base station in response to the third message and based on monitoring the control channel according to the second monitoring configuration.

The contention resolution message component 935 may receive a contention resolution message from the base station based on monitoring the control channel according to the first monitoring configuration, where monitoring the control channel according to the second monitoring configuration is based on receiving the contention resolution message. In some cases, the contention resolution message includes an indication of the second monitoring configuration.

In some examples, the contention resolution message component 935 may receive a contention resolution message from the base station based on monitoring the control channel according to the third monitoring configuration, where the contention resolution message successfully completes contention resolution.

The capability component 945 may transmit a capability indication to the base station indicating that the UE supports the second monitoring configuration, where monitoring the control channel according to the second monitoring configuration is based on the capability indication. In some examples, the capability component 945 may transmit the capability indication in the third message of the random access procedure. In some examples, the capability component 945 may transmit the capability indication in a capability message prior to transmitting the first message.

FIG. 10 shows a diagram of a system 1000 including a device 1005 that supports DRX for EDT in accordance with aspects of the present disclosure. The device 1005 may be an example of or include the components of device 705, device 805, or a UE 115 as described herein. The device 1005 may include components for bi-directional voice and data communications including components for transmitting and receiving communications, including a communications manager 1010, an I/O controller 1015, a transceiver 1020, an antenna 1025, memory 1030, and a processor 1040. These components may be in electronic communication via one or more buses (e.g., bus 1045).

The communications manager 1010 may transmit a first message of a random access procedure to a base station, monitor a control channel according to a first monitoring configuration for control information associated with a second message of the random access procedure, monitor the control channel according to a second monitoring configuration for control information associated with a fourth message of the random access procedure, where the second monitoring configuration is different than the first monitoring configuration, receive the second message from the base station in response to the first message and based on monitoring the control channel according to the first monitoring configuration, the second message including a grant for a first set of uplink resources for transmitting a third message of the random access procedure to the base station, transmit the third message to the base station using the first set of uplink resources, the third message including a data payload, and receive the fourth message from the base station in response to the third message and based on monitoring the control channel according to the second monitoring configuration.

The I/O controller 1015 may manage input and output signals for the device 1005. The I/O controller 1015 may also manage peripherals not integrated into the device 1005. In some cases, the I/O controller 1015 may represent a physical connection or port to an external peripheral. In some cases, the I/O controller 1015 may utilize an operating system such as iOS®, ANDROID®, MS-DOS®, MS-WINDOWS®, OS/2®, UNIX®, LINUX®, or another known operating system. In other cases, the I/O controller 1015 may represent or interact with a modem, a keyboard, a mouse, a touchscreen, or a similar device. In some cases, the I/O controller 1015 may be implemented as part of a processor. In some cases, a user may interact with the device 1005 via the I/O controller 1015 or via hardware components controlled by the I/O controller 1015.

The transceiver 1020 may communicate bi-directionally, via one or more antennas, wired, or wireless links as described above. For example, the transceiver 1020 may represent a wireless transceiver and may communicate bi-directionally with another wireless transceiver. The transceiver 1020 may also include a modem to modulate the packets and provide the modulated packets to the antennas for transmission, and to demodulate packets received from the antennas.

In some cases, the wireless device may include a single antenna 1025. However, in some cases the device may have more than one antenna 1025, which may be capable of concurrently transmitting or receiving multiple wireless transmissions.

The memory 1030 may include random-access memory (RAM) and read-only memory (ROM). The memory 1030 may store computer-readable, computer-executable code 1035 including instructions that, when executed, cause the processor to perform various functions described herein. In some cases, the memory 1030 may contain, among other things, a BIOS which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting DRX for EDT).

The code 1035 may include instructions to implement aspects of the present disclosure, including instructions to support wireless communications. The code 1035 may be stored in a non-transitory computer-readable medium such as system memory or other type of memory. In some cases, the code 1035 may not be directly executable by the processor 1040 but may cause a computer (e.g., when compiled and executed) to perform functions described herein.

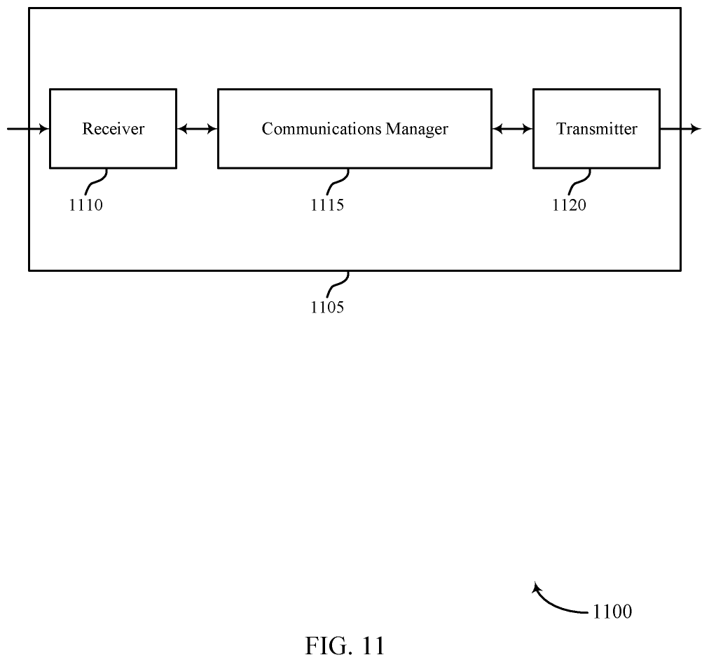

FIG. 11 shows a block diagram 1100 of a device 1105 that supports DRX for EDT in accordance with aspects of the present disclosure. The device 1105 may be an example of aspects of a base station 105 as described herein. The device 1105 may include a receiver 1110, a communications manager 1115, and a transmitter 1120. The device 1105 may also include a processor. Each of these components may be in communication with one another (e.g., via one or more buses).

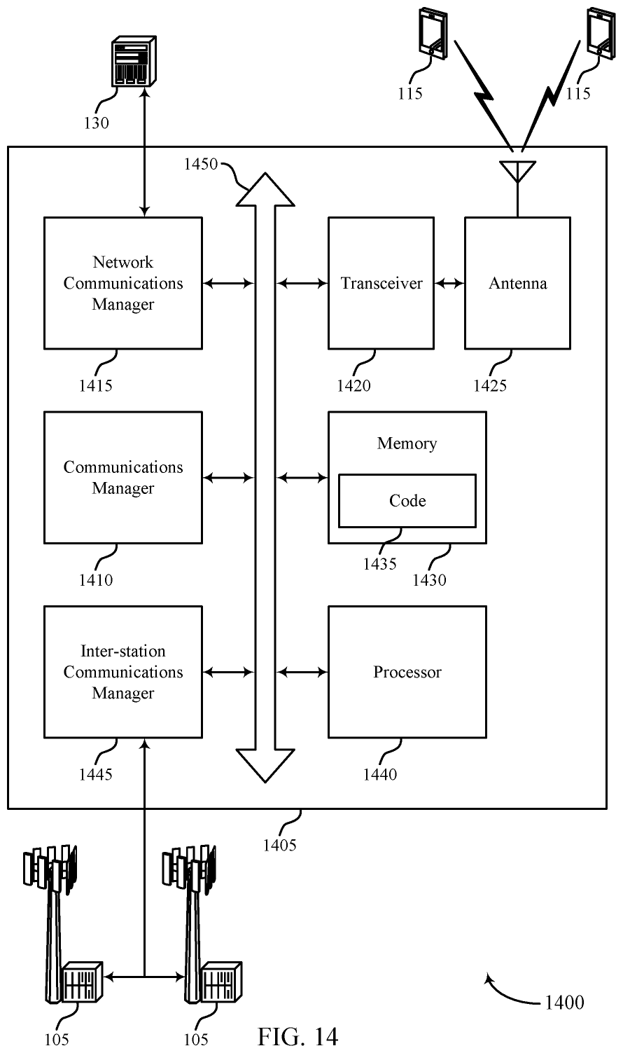

The receiver 1110 may receive information such as packets, user data, or control information associated with various information channels (e.g., control channels, data channels, and information related to DRX for EDT, etc.). Information may be passed on to other components of the device 1105. The receiver 1110 may be an example of aspects of the transceiver 1420 described with reference to FIG. 14. The receiver 1110 may utilize a single antenna or a set of antennas.

The communications manager 1115 may receive a first message of a random access procedure from a UE, transmit a second message to the UE in response to the first message, the second message including control information mapped to a first monitoring occasion determined according to a first monitoring configuration used by the UE for monitoring a control channel, the second message including a grant for a first set of uplink resources for the UE for transmitting a third message of the random access procedure, receive the third message over the first set of uplink resources, the third message including a data payload, and transmit a fourth message in response to the third message, the fourth message including control information mapped to a second monitoring occasion determined according to a second monitoring configuration used by the UE for monitoring the control channel, where the second monitoring configuration is different than the first monitoring configuration. The communications manager 1115 may be an example of aspects of the communications manager 1410 described herein.

The communications manager 1115, or its sub-components, may be implemented in hardware, code (e.g., software or firmware) executed by a processor, or any combination thereof. If implemented in code executed by a processor, the functions of the communications manager 1115, or its sub-components may be executed by a general-purpose processor, a DSP, an ASIC, a FPGA or other programmable logic device, discrete gate or transistor logic, discrete hardware components, or any combination thereof designed to perform the functions described in the present disclosure.

The communications manager 1115, or its sub-components, may be physically located at various positions, including being distributed such that portions of functions are implemented at different physical locations by one or more physical components. In some examples, the communications manager 1115, or its sub-components, may be a separate and distinct component in accordance with various aspects of the present disclosure. In some examples, the communications manager 1115, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 1120 may transmit signals generated by other components of the device 1105. In some examples, the transmitter 1120 may be collocated with a receiver 1110 in a transceiver module. For example, the transmitter 1120 may be an example of aspects of the transceiver 1420 described with reference to FIG. 14. The transmitter 1120 may utilize a single antenna or a set of antennas.

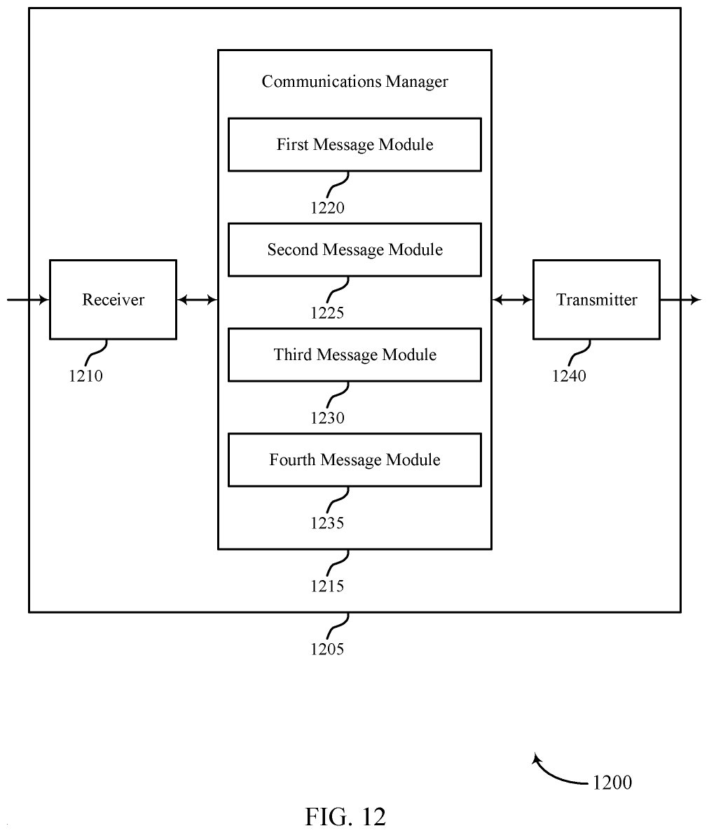

FIG. 12 shows a block diagram 1200 of a device 1205 that supports DRX for EDT in accordance with aspects of the present disclosure. The device 1205 may be an example of aspects of a device 1105, or a base station 105 as described herein. The device 1205 may include a receiver 1210, a communications manager 1215, and a transmitter 1240. The device 1205 may also include a processor. Each of these components may be in communication with one another (e.g., via one or more buses).

The receiver 1210 may receive information such as packets, user data, or control information associated with various information channels (e.g., control channels, data channels, and information related to DRX for EDT, etc.). Information may be passed on to other components of the device 1205. The receiver 1210 may be an example of aspects of the transceiver 1420 described with reference to FIG. 14. The receiver 1210 may utilize a single antenna or a set of antennas.

The communications manager 1215 may be an example of aspects of the communications manager 1115 as described herein. The communications manager 1215 may include a first message module 1220, a second message module 1225, a third message module 1230, and a fourth message module 1235. The communications manager 1215 may be an example of aspects of the communications manager 1410 described herein.

The first message module 1220 may receive a first message of a random access procedure from a UE.

The second message module 1225 may transmit a second message to the UE in response to the first message, the second message including control information mapped to a first monitoring occasion determined according to a first monitoring configuration used by the UE for monitoring a control channel, the second message including a grant for a first set of uplink resources for the UE for transmitting a third message of the random access procedure.

The third message module 1230 may receive the third message over the first set of uplink resources, the third message including a data payload.

The fourth message module 1235 may transmit a fourth message in response to the third message, the fourth message including control information mapped to a second monitoring occasion determined according to a second monitoring configuration used by the UE for monitoring the control channel, where the second monitoring configuration is different than the first monitoring configuration.

The transmitter 1240 may transmit signals generated by other components of the device 1205. In some examples, the transmitter 1240 may be collocated with a receiver 1210 in a transceiver module. For example, the transmitter 1240 may be an example of aspects of the transceiver 1420 described with reference to FIG. 14. The transmitter 1240 may utilize a single antenna or a set of antennas.

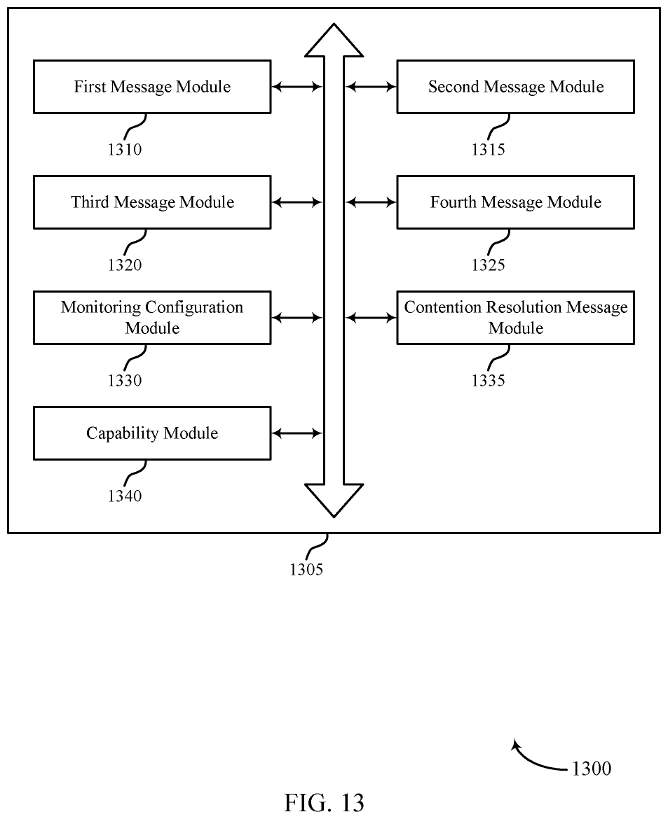

FIG. 13 shows a block diagram 1300 of a communications manager 1305 that supports DRX for EDT in accordance with aspects of the present disclosure. The communications manager 1305 may be an example of aspects of a communications manager 1115, a communications manager 1215, or a communications manager 1410 described herein. The communications manager 1305 may include a first message module 1310, a second message module 1315, a third message module 1320, a fourth message module 1325, a monitoring configuration module 1330, a contention resolution message module 1335, and a capability module 1340. Each of these modules may communicate, directly or indirectly, with one another (e.g., via one or more buses).

The first message module 1310 may receive a first message of a random access procedure from a UE.

The second message module 1315 may transmit a second message to the UE in response to the first message, the second message including control information mapped to a first monitoring occasion determined according to a first monitoring configuration used by the UE for monitoring a control channel, the second message including a grant for a first set of uplink resources for the UE for transmitting a third message of the random access procedure.

The third message module 1320 may receive the third message over the first set of uplink resources, the third message including a data payload.

The fourth message module 1325 may transmit a fourth message in response to the third message, the fourth message including control information mapped to a second monitoring occasion determined according to a second monitoring configuration used by the UE for monitoring the control channel, where the second monitoring configuration is different than the first monitoring configuration.

The monitoring configuration module 1330 may transmit broadcast information, an RRC message, or a MAC-CE to the UE including an indication of the second monitoring configuration. In some cases, a contention resolution message includes an indication of the second monitoring configuration.

In some cases, the first monitoring configuration includes a first spacing in time between monitoring occasions and the second monitoring configuration includes a second spacing in time between monitoring occasions. In some cases, the second monitoring configuration includes a cycle time duration between each of a plurality of sets of monitoring occasions and an on duration for the each of the plurality of sets of monitoring occasions, the plurality of sets of monitoring occasions to be monitored by the UE according to the second monitoring configuration. In some cases, the indication of the second monitoring configuration includes a multiplication factor to be applied to a spacing between each monitoring occasion or applied to a cycle time duration between each of a plurality of sets of monitoring occasions.

The contention resolution message module 1335 may transmit a contention resolution message to the UE, where mapping the control information associated with the fourth message to the second monitoring occasion determined according to the second monitoring configuration is based on transmitting the contention resolution message. In some cases, the contention resolution message includes control information transmitted in a third monitoring occasion determined according to the first monitoring configuration. In some cases, the contention resolution message includes control information transmitted in a third monitoring occasion determined according to a third monitoring configuration, the third monitoring configuration different than the second monitoring configuration.

The capability module 1340 may receive a capability indication from the UE indicating that the UE supports the second monitoring configuration. In some examples, the capability module 1340 may receive the capability indication in the third message of the random access procedure.

FIG. 14 shows a diagram of a system 1400 including a device 1405 that supports DRX for EDT in accordance with aspects of the present disclosure. The device 1405 may be an example of or include the components of device 1105, device 1205, or a base station 105 as described herein. The device 1405 may include components for bi-directional voice and data communications including components for transmitting and receiving communications, including a communications manager 1410, a network communications manager 1415, a transceiver 1420, an antenna 1425, memory 1430, a processor 1440, and an inter-station communications manager 1445. These components may be in electronic communication via one or more buses (e.g., bus 1450).

The communications manager 1410 may receive a first message of a random access procedure from a UE, transmit a second message to the UE in response to the first message, the second message including control information mapped to a first monitoring occasion determined according to a first monitoring configuration used by the UE for monitoring a control channel, the second message including a grant for a first set of uplink resources for the UE for transmitting a third message of the random access procedure, receive the third message over the first set of uplink resources, the third message including a data payload, and transmit a fourth message in response to the third message, the fourth message including control information mapped to a second monitoring occasion determined according to a second monitoring configuration used by the UE for monitoring the control channel, where the second monitoring configuration is different than the first monitoring configuration.

The network communications manager 1415 may manage communications with the core network (e.g., via one or more wired backhaul links). For example, the network communications manager 1415 may manage the transfer of data communications for client devices, such as one or more UEs 115.

The transceiver 1420 may communicate bi-directionally, via one or more antennas, wired, or wireless links as described above. For example, the transceiver 1420 may represent a wireless transceiver and may communicate bi-directionally with another wireless transceiver. The transceiver 1420 may also include a modem to modulate the packets and provide the modulated packets to the antennas for transmission, and to demodulate packets received from the antennas.

In some cases, the wireless device may include a single antenna 1425. However, in some cases the device may have more than one antenna 1425, which may be capable of concurrently transmitting or receiving multiple wireless transmissions.

The memory 1430 may include RAM, ROM, or a combination thereof. The memory 1430 may store computer-readable code 1435 including instructions that, when executed by a processor (e.g., the processor 1440) cause the device to perform various functions described herein. In some cases, the memory 1430 may contain, among other things, a basic input/output system (BIOS) which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some cases, a memory controller may be integrated into processor 1440. The processor 1440 may be configured to execute computer-readable instructions stored in a memory (e.g., the memory 1430) to cause the device 1405 to perform various functions (e.g., functions or tasks supporting DRX for EDT).

The inter-station communications manager 1445 may manage communications with other base station 105, and may include a controller or scheduler for controlling communications with UEs 115 in cooperation with other base stations 105. For example, the inter-station communications manager 1445 may coordinate scheduling for transmissions to UEs 115 for various interference mitigation techniques such as beamforming or joint transmission. In some examples, the inter-station communications manager 1445 may provide an X2 interface within an LTE/LTE-A wireless communication network technology to provide communication between base stations 105.

The code 1435 may include instructions to implement aspects of the present disclosure, including instructions to support wireless communications. The code 1435 may be stored in a non-transitory computer-readable medium such as system memory or other type of memory. In some cases, the code 1435 may not be directly executable by the processor 1440 but may cause a computer (e.g., when compiled and executed) to perform functions described herein.

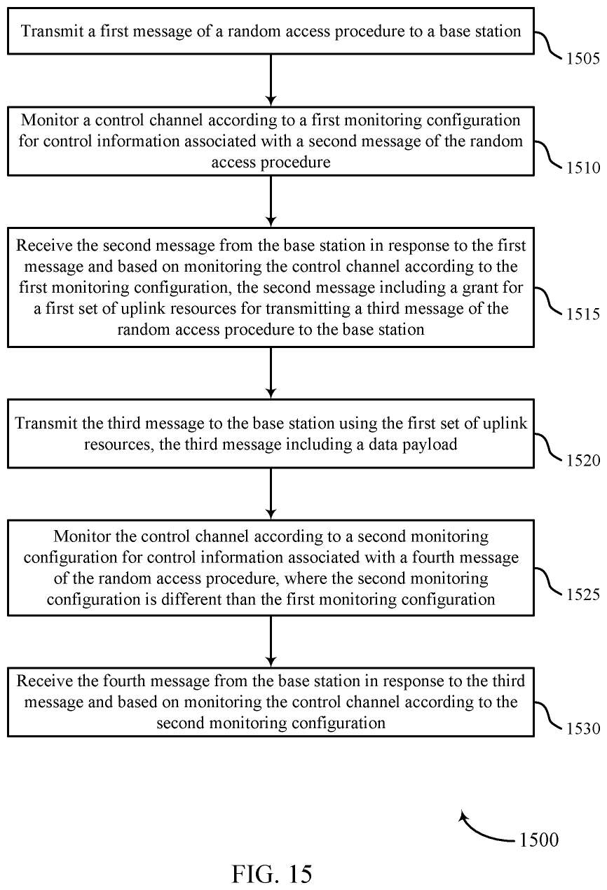

FIG. 15 shows a flowchart illustrating a method 1500 that supports DRX for EDT in accordance with aspects of the present disclosure. The operations of method 1500 may be implemented by a UE 115 or its components as described herein. For example, the operations of method 1500 may be performed by a communications manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 1505, the UE may transmit a first message of a random access procedure to a base station. The operations of 1505 may be performed according to the methods described herein. In some examples, aspects of the operations of 1505 may be performed by a first message component as described with reference to FIGS. 7 through 10.

At 1510, the UE may monitor a control channel according to a first monitoring configuration for control information associated with a second message of the random access procedure. The operations of 1510 may be performed according to the methods described herein. In some examples, aspects of the operations of 1510 may be performed by a monitoring component as described with reference to FIGS. 7 through 10.

At 1515, the UE may receive the second message from the base station in response to the first message and based on monitoring the control channel according to the first monitoring configuration, the second message including a grant for a first set of uplink resources for transmitting a third message of the random access procedure to the base station. The operations of 1515 may be performed according to the methods described herein. In some examples, aspects of the operations of 1515 may be performed by a second message component as described with reference to FIGS. 7 through 10.

At 1520, the UE may transmit the third message to the base station using the first set of uplink resources, the third message including a data payload. The operations of 1520 may be performed according to the methods described herein. In some examples, aspects of the operations of 1520 may be performed by a third message component as described with reference to FIGS. 7 through 10.

At 1525, the UE may monitor the control channel according to a second monitoring configuration for control information associated with a fourth message of the random access procedure, where the second monitoring configuration is different than the first monitoring configuration. The operations of 1525 may be performed according to the methods described herein. In some examples, aspects of the operations of 1525 may be performed by a monitoring component as described with reference to FIGS. 7 through 10.

At 1530, the UE may receive the fourth message from the base station in response to the third message and based on monitoring the control channel according to the second monitoring configuration. The operations of 1530 may be performed according to the methods described herein. In some examples, aspects of the operations of 1530 may be performed by a fourth message component as described with reference to FIGS. 7 through 10.

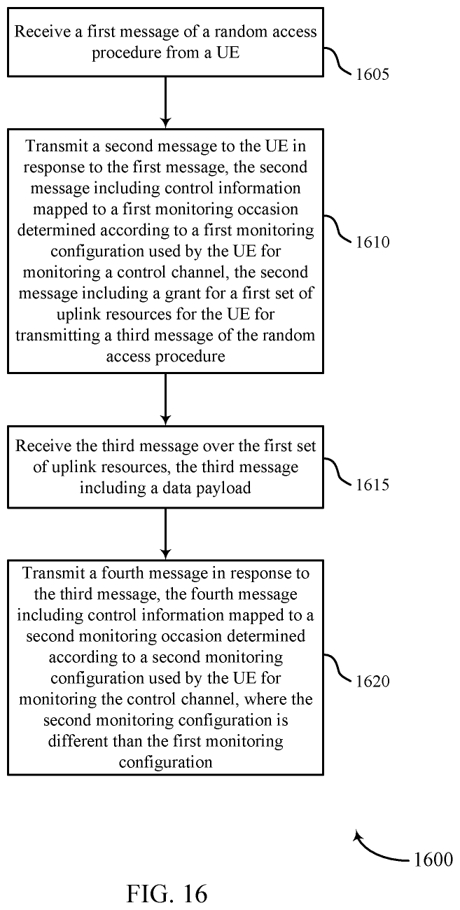

FIG. 16 shows a flowchart illustrating a method 1600 that supports DRX for EDT in accordance with aspects of the present disclosure. The operations of method 1600 may be implemented by a base station 105 or its components as described herein. For example, the operations of method 1600 may be performed by a communications manager as described with reference to FIGS. 11 through 14. In some examples, a base station may execute a set of instructions to control the functional elements of the base station to perform the functions described below. Additionally or alternatively, a base station may perform aspects of the functions described below using special-purpose hardware.

At 1605, the base station may receive a first message of a random access procedure from a UE. The operations of 1605 may be performed according to the methods described herein. In some examples, aspects of the operations of 1605 may be performed by a first message module as described with reference to FIGS. 11 through 14.

At 1610, the base station may transmit a second message to the UE in response to the first message, the second message including control information mapped to a first monitoring occasion determined according to a first monitoring configuration used by the UE for monitoring a control channel, the second message including a grant for a first set of uplink resources for the UE for transmitting a third message of the random access procedure. The operations of 1610 may be performed according to the methods described herein. In some examples, aspects of the operations of 1610 may be performed by a second message module as described with reference to FIGS. 11 through 14.

At 1615, the base station may receive the third message over the first set of uplink resources, the third message including a data payload. The operations of 1615 may be performed according to the methods described herein. In some examples, aspects of the operations of 1615 may be performed by a third message module as described with reference to FIGS. 11 through 14.

At 1620, the base station may transmit a fourth message in response to the third message, the fourth message including control information mapped to a second monitoring occasion determined according to a second monitoring configuration used by the UE for monitoring the control channel, where the second monitoring configuration is different than the first monitoring configuration. The operations of 1620 may be performed according to the methods described herein. In some examples, aspects of the operations of 1620 may be performed by a fourth message module as described with reference to FIGS. 11 through 14.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication at a user equipment (UE), comprising:
transmitting a first message of a random access procedure to a base station;
monitoring a control channel according to a first monitoring configuration for control information associated with a second message of the random access procedure;
receiving the second message from the base station in response to the first message and based at least in part on monitoring the control channel according to the first monitoring configuration, the second message comprising a grant for a first set of uplink resources for transmitting a third message of the random access procedure to the base station;
transmitting the third message to the base station using the first set of uplink resources, the third message comprising a data payload;
monitoring the control channel according to a second monitoring configuration for control information associated with a fourth message of the random access procedure, wherein the second monitoring configuration is different than the first monitoring configuration; and
receiving the fourth message from the base station in response to the third message and based at least in part on monitoring the control channel according to the second monitoring configuration.

2. The method of claim 1, wherein the first monitoring configuration comprises a first spacing in time between monitoring occasions and the second monitoring configuration comprises a second, different spacing in time between monitoring occasions.

3. The method of claim 1, wherein the second monitoring configuration comprises a cycle time duration between each of a plurality of sets of monitoring occasions and an on duration for the each of the plurality of sets of monitoring occasions, the plurality of sets of monitoring occasions to be monitored according to the second monitoring configuration.

4. The method of claim 1, further comprising:
receiving an indication of the second monitoring configuration from the base station, wherein monitoring the control channel according to the second monitoring configuration is based at least in part on receiving the indication of the second monitoring configuration.

5. The method of claim 4, further comprising:
receiving broadcast information, a radio resource control (RRC) message, or a media access control control element (MAC-CE) from the base station comprising the indication of the second monitoring configuration.

6. The method of claim 1, further comprising:
receiving a contention resolution message from the base station based at least in part on monitoring the control channel according to the first monitoring configuration, wherein monitoring the control channel according to the second monitoring configuration is based at least in part on receiving the contention resolution message.

7. The method of claim 6, wherein the contention resolution message comprises an indication of the second monitoring configuration.

8. The method of claim 7, wherein the indication of the second monitoring configuration comprises a multiplication factor to be applied to a spacing between each monitoring occasion or applied to a cycle time duration between each of a plurality of sets of monitoring occasions.

9. The method of claim 1, further comprising:
beginning to monitor the control channel according to a third monitoring configuration upon transmitting the third message of the random access procedure.

10. The method of claim 9, further comprising:
receiving a contention resolution message from the base station based at least in part on monitoring the control channel according to the third monitoring configuration, wherein the contention resolution message successfully completes contention resolution.

11. The method of claim 10, wherein the third monitoring configuration is the same as the second monitoring configuration.

12. The method of claim 10, wherein the third monitoring configuration is different than the second monitoring configuration, and the contention resolution message comprises an indication of the second monitoring configuration.

13. The method of claim 1, further comprising:
transmitting a capability indication to the base station indicating that the UE supports the second monitoring configuration, wherein monitoring the control channel according to the second monitoring configuration is based at least in part on the capability indication.

14. The method of claim 13, further comprising:
transmitting the capability indication in the third message of the random access procedure or in a capability message prior to transmitting the first message.

15. The method of claim 13, wherein:
monitoring the control channel according to the second monitoring configuration is based at least in part on the base station supporting the second monitoring configuration.

16. A method for wireless communication at a base station, comprising:
receiving a first message of a random access procedure from a user equipment (UE);
transmitting a second message to the UE in response to the first message, the second message comprising control information mapped to a first monitoring occasion determined according to a first monitoring configuration used by the UE for monitoring a control channel, the second message comprising a grant for a first set of uplink resources for the UE for transmitting a third message of the random access procedure;
receiving the third message over the first set of uplink resources, the third message comprising a data payload; and
transmitting a fourth message in response to the third message, the fourth message comprising control information mapped to a second monitoring occasion determined according to a second monitoring configuration used by the UE for monitoring the control channel, wherein the second monitoring configuration is different than the first monitoring configuration.

17. The method of claim 16, wherein the first monitoring configuration comprises a first spacing in time between monitoring occasions and the second monitoring configuration comprises a second, different spacing in time between monitoring occasions.

18. The method of claim 16, wherein the second monitoring configuration comprises a cycle time duration between each of a plurality of sets of monitoring occasions and an on duration for the each of the plurality of sets of monitoring occasions, the plurality of sets of monitoring occasions to be monitored by the UE according to the second monitoring configuration.

19. The method of claim 16, further comprising:
transmitting broadcast information, a radio resource control (RRC) message, or a media access control control element (MAC-CE) to the UE comprising an indication of the second monitoring configuration.

20. The method of claim 16, further comprising:
transmitting a contention resolution message to the UE, wherein mapping the control information associated with the fourth message to the second monitoring occasion determined according to the second monitoring configuration is based at least in part on transmitting the contention resolution message.

21. The method of claim 20, wherein the contention resolution message comprises an indication of the second monitoring configuration.

22. The method of claim 21, wherein the indication of the second monitoring configuration comprises a multiplication factor to be applied to a spacing between each monitoring occasion or applied to a cycle time duration between each of a plurality of sets of monitoring occasions.

23. The method of claim 20, wherein the contention resolution message comprises control information transmitted in a third monitoring occasion determined according to the first monitoring configuration.

24. The method of claim 20, wherein the contention resolution message comprises control information transmitted in a third monitoring occasion determined according to a third monitoring configuration, the third monitoring configuration different than the second monitoring configuration.

25. The method of claim 16, further comprising:
receiving a capability indication from the UE indicating that the UE supports the second monitoring configuration.

26. An apparatus for wireless communication at a user equipment (UE), comprising:
a processor,
memory coupled with the processor; and
instructions stored in the memory and executable by the processor to cause the apparatus to:
transmit a first message of a random access procedure to a base station;
monitor a control channel according to a first monitoring configuration for control information associated with a second message of the random access procedure;
receive the second message from the base station in response to the first message and based at least in part on monitoring the control channel according to the first monitoring configuration, the second message comprising a grant for a first set of uplink resources for transmitting a third message of the random access procedure to the base station;
transmit the third message to the base station using the first set of uplink resources, the third message comprising a data payload;
monitor the control channel according to a second monitoring configuration for control information associated with a fourth message of the random access procedure, wherein the second monitoring configuration is different than the first monitoring configuration; and
receive the fourth message from the base station in response to the third message and based at least in part on monitoring the control channel according to the second monitoring configuration.

27. The apparatus of claim 26, wherein the first monitoring configuration comprises a first spacing in time between monitoring occasions and the second monitoring configuration comprises a second, different spacing in time between monitoring occasions.

28. The apparatus of claim 26, wherein the second monitoring configuration comprises a cycle time duration between each of a plurality of sets of monitoring occasions and an on duration for the each of the plurality of sets of monitoring occasions, the plurality of sets of monitoring occasions to be monitored according to the second monitoring configuration.

29. An apparatus for wireless communication at a base station, comprising:
a processor,
memory coupled with the processor; and
instructions stored in the memory and executable by the processor to cause the apparatus to:
receive a first message of a random access procedure from a user equipment (UE);
transmit a second message to the UE in response to the first message, the second message comprising control information mapped to a first monitoring occasion determined according to a first monitoring configuration used by the UE for monitoring a control channel, the second message comprising a grant for a first set of uplink resources for the UE for transmitting a third message of the random access procedure;
receive the third message over the first set of uplink resources, the third message comprising a data payload; and
transmit a fourth message in response to the third message, the fourth message comprising control information mapped to a second monitoring occasion determined according to a second monitoring configuration used by the UE for monitoring the control channel, wherein the second monitoring configuration is different than the first monitoring configuration.

30. The apparatus of claim 29, wherein the first monitoring configuration comprises a first spacing in time between monitoring occasions and the second monitoring configuration comprises a second, different spacing in time between monitoring occasions.
